(19) United States
(12) Patent Application Publication
(10) Pub. No.: US 2023/0289681 A1
(43) Pub. Date: Sep. 14, 2023

(54) Database Processing for Resolving Resource Deadlocks and for Efficient Resource

(71) Applicant: C2S FIN LLC, Halaki-Istanbul (TR)

(72) Inventors: Ridvan ÇABUKEL, Halaki-Istanbul (TR); Fuat OGUZ, West Lafayette, IN (US); Ali ÇABUKEL, London (GB)

(73) Assignee: C2S FIN LLC, Halaki-Istanbul (TR)

(21) Appl. No.: 17/788,251

(22) PCT Filed: Jan. 20, 2021
(86) PCT No.: PCT/US2021/014182

§ 371 Date: Jun. 22, 2022

Related U.S. Application Data
(60) Provisional application No. 62/985,658, filed on Mar. 5, 2020.
(60) Provisional application No. 62/963,515, filed on Jan. 20, 2020.

(51) Int. Cl. G06Q 10/0631; G06Q 20/02; G06Q 20/10; G06Q 50/26

(52) U.S. Cl. CPC G06Q 10/06313; G06Q 20/02; G06Q 20/102; G06Q 50/26

(57) ABSTRACT

A computer processor processes a database to identify a chain of database records. The records have links to other records. The processing identifies a chain of records though the links such that the records and links taken together as a chain meet a property specified as a parameter to the processing, the property describing a property of the chain as a whole. After the chain is identified, the computer processor issues computer messages to computers of a settlement agent, to holders of the goods or instruments, and/ or to transfer agents for the goods or instruments, instructing computers of recipient agents or holders to transfer goods or instruments under a global transaction that settles obligations of the chain.

### BACKGROUND

This application is a § 371 national phase entry of International App. Ser. No. PCT/US2021/014182, filed Jan. 20, 2021. The ‘182 application claims priority from U.S. Provisional Pat. Application Ser. No. 62/963,515, filed Jan. 20, 2020, titled Credit Clearance System, and claims priority from U.S. Provisional Pat. Application Ser. No. 62/985,658 filed Mar. 5, 2020, titled Credit Clearance System with Maturities, both incorporated by reference.

This application relates to database programs for resolving resource deadlocks.

### SUMMARY

In general, in a first aspect, the invention features a method, and a computer with instructions for performance of the method. A computer processor processes a database to identify a chain of database records. The records have links to other records. The processing identifies a chain of records though the links such that the records and links taken together as a chain meet a property specified as a parameter to the processing, the property describing a property of the chain as a whole. After the chain is identified, the computer processor issues computer messages to computers of a settlement agent, to holders of the goods or instruments, and/or to transfer agents for the goods or instruments, instructing computers of recipient agents or holders to transfer goods or instruments under a global transaction that settles obligations of the chain.

In general, in a second aspect, the invention features a method, and a computer with instructions for performance of the method. A computer processor processes a database to identify a chain of database records. Records of the database describe respective payable/receivable obligations. Each payable/receivable obligation record stores an obligor, an obligee, and an amount. The processor is programmed to identify a chain containing records such that the obligee of a record in the chain corresponds to the obligor of the next record in the chain. After the chain is identified, the computer processor issues instructions to computers of a settlement agent, to parties to the payables/receivables, and/or to transfer agents for the payables/receivables, instructing computers of agents or holders to transfer funds or payment obligations under a global transaction that settles obligations of the chain.

Embodiments of the invention may include one or more of the following features. Records of the database may describe books due to libraries on inter-library loan from a source library to a destination library for loan to a patron. The processing may be programmed to identify a chain of records in the database, the chain containing records such that (for records other than the first and last in the chain) the destination library of a record in the chain is the source library of the next record in the chain. After the chain is identified, the computer processor may issue instructions to computers of destination libraries to each hold the respective book when returned by the borrower, and to cancel obligations of destination libraries to return the books to the source libraries, and to update the holding inventories of the libraries. Records of the database may describe locations of shipping containers, and obligations to return the shipping containers from current ports to destination ports, the processing programmed to identify a chain of records in the database, the chain containing records such that (for records other than the first and last in the chain) the destination port of a record in the chain is the current port of the next record in the chain. These features may be used singly, or in combination with each other. The obligee of the last record in the chain ma correspond to the obligor of the first record in the chain. After the chain is identified, the processor may issue instructions to a settlement agent, to holders of the payables/receivables, and/or to transfer agents for the payables/receivables, to extinguish an amount of each payable/receivable of the chain. The obligor of the first record in the chain may be a public sector entity. After the chain is identified, the processor may issue instructions to a settlement agent, to holders of the payables/receivables, and/or to transfer agents for the payables/receivables, to extinguish an amount of each payable/receivable of the chain; the amount monotonically decreasing at each record of the chain except the last. The property is a chain of payment obligations, in which the obligor of the last obligation in the chain is chosen because that obligor has a lower credit rating than the first obligor in the chain, and the global transaction is to replace the obligor of the last obligation with the obligor of the first obligation and to retire at least in part the obligations of the links of the chain other than the first. The records describing payable/receivable obligations. Each payable/receivable obligation record may store an obligor, an obligee, and an amount, the processing programmed to compute an optimized allocation of payable/receivable obligations among obligees for distribution across various parameters programmed into an optimization model. After the chain is identified, the computer processor may issue instructions to a settlement agent, to holders of the payable/receivable obligations, and/or to transfer agents for the payables/receivables, to transfer funds or payment obligations, and to create new payable/receivable obligations, to achieve the computed optimized allocation. After the chain is identified, the computer processor may issue instructions to computers of shippers and ports to each hold the respective shipping containers of the records in the chain, and to cancel obligations to transfer the shipping containers to the destination ports. The chain may be formed of imperfectly-fungible instances of goods or instruments, and the processing to identify the chain may rely on a selected degree of difference to identify chains of imperfectly fungible obligations. The computer processor may communicate with computer systems of obligors and obligees to gather accounts payable and accounts receivable information. At least one payee may corresponding to a payor may be different parties under an arrangement to transfer funds between each other, the correspondence having been communicated to the computer processor before the database processing begins. The database processing may be programmed to recognize payable/receivable obligations having different maturity dates from each other as eligible for matching into a chain, a degree of acceptable difference having been communicated to the computer processor before the database processing begins. The computer processor may be programmed to issue instructions to agents and/or holders to settle the payable/receivable obligations at notional value, or at present value. At least one of the obligors may be a liquidity lender, and the payable/receivable obligation for that liquidity lender may be not recorded in the database before the database processing begins. The database processing may run in a series of passes, programmed to promote resolution of some payable/receivable obligations over payable/receivable obligations. The database processing may compute the chain as a directed graph among the database records. The database processing may be computed the chain using a linear programming optimization algorithm. After the chain may be identified, the computer processor may issue instructions to an escrow agent instructing the escrow agent to transfer funds or payment obligations among accounts in trust for the obligors and obligees held by a common transfer agent. After the chain is identified, the computer processor may issue instructions to transfer funds over a payment network.

The term “optimize” is used in this document in the computational sense, to mean “improved to the degree provided by the relevant computational model.” An “optimal” solution may be sub-optimal if it could be evaluated with perfect knowledge outside the computation.

The above advantages and features are of representative embodiments only, and are presented only to assist in understanding the invention. They may be combined with each other, and may be combined with other features, some described below, some not. It should be understood that they are not to be considered limitations on the invention as defined by the claims. Additional features and advantages of embodiments of the invention will become apparent in the following description, from the drawings, and from the claims.

### DESCRIPTION OF THE DRAWINGS

FIG. 1 are block diagrams of computer systems.

FIGS. 2, 4, 5, 6, and 10 are graphs of obligations and transfers among parties.

FIG. 3 is a matrix of fund transfers among parties.

FIGS. 7, 8, and 9 are flowcharts.

### DESCRIPTION

The Description is organized as follows.
I. Overview
II. Example 1: Library books
III. Example 2: Shipping containers
IV. Example 3: Credit deadlock
   IV.A. Credit deadlocks and their resolution via a database analysis
   IV.B. Four types of chains: zero-sum chains, public chains, discount chains, and diversification chains
   IV.C. Parties
      IV.C.1. Software used by users
      IV.C.2.Liquidity lender
      IV.C.3.System Operator 800
      IV.C.4.Primary users
V. Implementation via a database
   V.A. Database structure
   V.B. Data entry
   V.C. Calculation of zero-sum chains
   V.D. Calculation of Diversification Chains
   V.E. Calculation of Discount Chains
   V.F. Implementation: transfer of money through accounts
      V.F.1. Cut-off time 112
      V.F.2. Approximate matching
      V.F.3. Escrow or special purpose accounts
      V.F.4. Block clearing using banks and SWIFT as transfer
      V.F.5. Block clearing using API-based transfer agents such as Apple Pay, Google Pay
      V.F.6. Transfers using a net-offset clearer (ACH)
      V.F.7. Combining transfer networks
   V.G. Present value of receivables and payables
   V.H. Defaults
VI. Computer implementation

### I. Overview

Deadlocks arise when dependencies in a system are circularly-dependent. For a first example, in 2020, shipping containers were under an apparent shortage. The same number of containers were available as in 2019; however, empty containers were simply in the wrong place at the wrong time, and ordinary demand forces were not serving to reallocate them from ports where empty containers piled up, to ports where goods were waiting to be shipped. An algorithm may identify this misallocation, and instruct that empty containers are to be deadheaded from one port to another. In a second example, inter-library loan of books can create situations where library A’s copy of a book has been loaned to a patron from library B, library B’s copy has been loaned to a patron from library C, and library C’s copy has been loaned to a patron of library A. An algorithm may detect this circular dependency, and instruct all three libraries to keep the copy that will be returned to that library. In a third example, manufacturer A may owe $100 to supplier B, supplier B may owe $100 to attorney C, and attorney C may owe $100 to manufacturer A. An algorithm may identify this circle of debt, and instruct all three to (simultaneously) retire the payable/receivable pairs.

A database may collect dependencies. An algorithm may find circular chains of dependency, or chains where the chain is nearly circular.

### II. Example 1: Library Books

Suppose a borrower wants to borrow a book from the Northtown Branch, Chicago Public Library, but the Northtown Champaign library’s copy is currently loaned out, so the Northtown branch inter-library loans the book from the Champaign, Illinois public library. The next day, a borrower in Champaign wants the book, but the Champaign library doesn’t have it, and inter-library loans it from Springfield. And a day later, the Springfield library needs the book, and inter-library loans it from the Uptown Branch, Chicago public library. Thus, there is a nearly-circular dependency (the Northtown and Uptown branches are geographically near each other, but not the same branch).

A computer system may survey the Illinois inter-library loan computer system to detect a near-cycle of dependencies. The computer system may instruct the Springfield and Champaign libraries to keep the copy returned to them, and may instruct the Northtown branch, when it receives the return book, to return it to Uptown instead of to Champaign.

### III. Example 2: Shipping Containers

A deadlock may arise where, for example, the Maersk shipping company has a shortage of containers in Osaka harbor, Mediterranean Shipping Co. may has a shortage in Long Beach, and COSCO may have a shortage in Shanghai. Each of the three may have too little freight to match the containers available in other ports, but an excess of freight relative to containers in other ports.

The shipping lines may cooperatively set up a computer system with a database of container needs and locations. An algorithm may survey the data provided by the shipping lines to identify opportunities for inter-line lending of containers to allow each to meet shipping commitments.

### IV. Example 3: Credit Deadlock

### IV.A. Credit Deadlocks and Their Resolution Via a Database Analysis

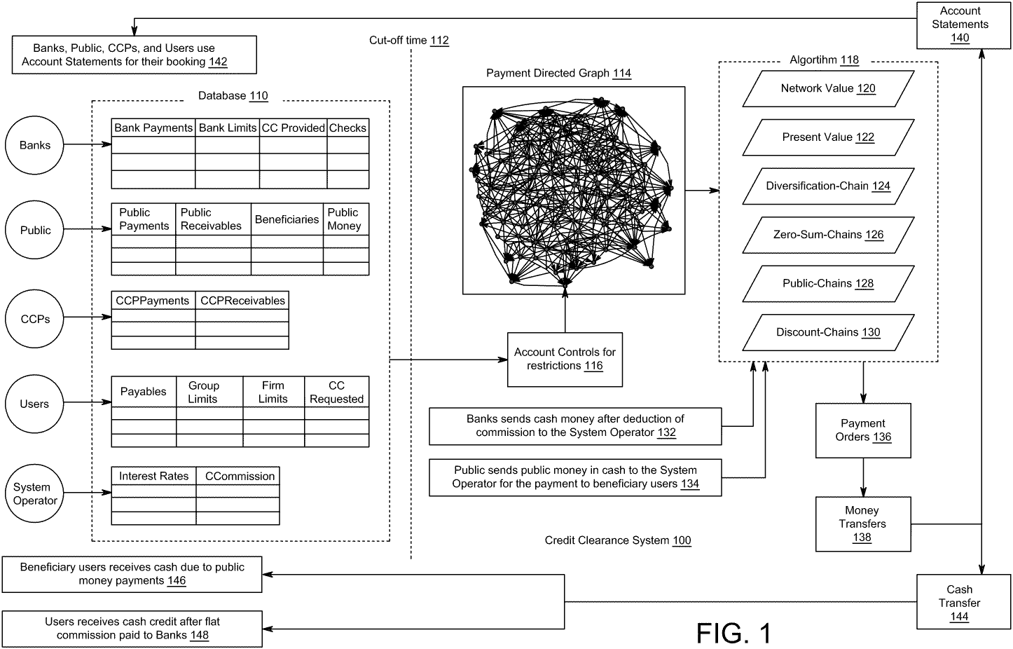

Referring to FIG. 1, sometimes parties find themselves in a credit deadlock. Every party may have sufficient assets to pay all debts as they come due, but because some of those assets are current or future receivables (rather than cash), parties can’t actually make good on their debts on a current cash basis. When enough parties are trapped in this, the result is a “credit crisis” or “liquidity crisis” that may affect an entire national economy. Credit clearance system 100 gathers information from parties that describes their accounts payables (debts owed to others) and receivables (debts owed by other to the party). Credit clearance system 100 identifies circular chains of credit deadlock, that is, circular chains of debt and credit that could be cleared if they can be detected and all settled simultaneously. Credit clearance system 100 arranges a short-term loan from a liquidity provider into the chain, and arranges payment to flow around the chain in a matter of seconds, and then when that payment has flowed around the chain, recovers the loan from the chain. This allows the liquidity provider to make a profit on a short-term, low-risk loan that wouldn’t otherwise be made. A small injection of credit may provide a large multiplier as it flows around the chain. For parties in the chain, nonperforming receivables are used to retire debt, and credit is freed up for other purposes.

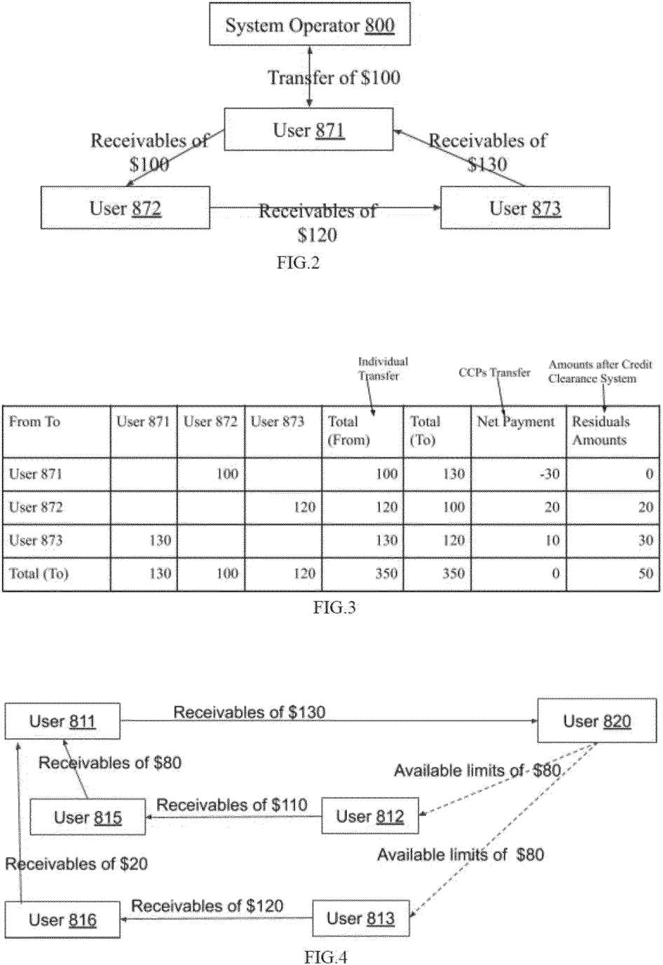

Referring to FIG. 2, users such as banks, governments, companies, businesses and individuals give payment orders to payment systems for the same day. Payment systems transfer the money among users’ accounts directly or by using Automated Clearing Houses (ACH). In order to complete this payment, payment systems require users to have a full coverage for the payment order in the users’ account or have adequate credit limits and collateral to obtain this money. Credit Clearance System 100 may assist in making payment even if the full amount is not currently in a user’s account. FIG. 2 shows a simplified model for payables entry and settlement authorizations among three users 871, 872, 873. User 871 owes $100 to User 872. User 872 owes $120 to User 873. User 873 owes $130 to User 871. Conventional payment systems require these three users to have the full amount in their accounts to initiate ACH payment orders. Therefore, these three users 871, 872, 873 would have to have a total of $350 ($100 + $120 + $130) in order to initiate these three payment orders. The users may authorize System Operator 800 to transfer money whenever a chain is established and a receivable is collected. This settlement authorization is a kind of standing instruction. This settlement authorization is conditional to any receivable amount being collected through the chain. The settlement authorization also authorizes System Operator 800 to conduct multiple partial transfers up the payable amount entered by the respective user. Credit clearance system 100 recognizes the cycle, and may issue payment orders to settle the payables/receivables. Credit clearance system 100 may be able to do so without the cash being in the users’ accounts, without taking credit risk, and without collateral.

The three users 871, 872, 873 may enter their payables into a database run by credit clearance system 100 and authorize credit clearance system 100 to issue a payment order at a given time (for example, t+1 or next day). Payment orders in the database create a payment directed graph 114. Then algorithm 118 of credit clearance system 100 determines a zero-sum chain 126 among users (user 871-> user 872 -> user 873 -> user 871) and determines the minimum value ($100) of any link of the chain. System Operator 800 or another liquidity lender lends the minimum amount ($100) to user 871 for a moment, and issues payment orders during the value date (i.e. 01.00 AM). At the end of the chain, the last payment order causes the funds to flow back into the account of the liquidity lender. Credit clearance system 100 may provide statements to users showing counterparties and amounts transferred.

Credit clearance system 100 may help banks, governments, central banks, automated clearing houses (ACH), companies, individuals and their counterparties to clear credit risk and circular deadlocks. Risks and deadlocks can be reduced by credit clearing through payment systems, network and graph algorithms, and optimization. Credit clearance system 100 may give options to users to pay their payables with the money received from their receivables. Credit clearance system 100 uses algorithm 118 to determine amounts to be transferred through accounts of users in a payment system such as central banks, banks, credit card companies, PayPal, Alipay, Google Pay, Novi, SWIFT, ACHs etc. Credit clearance system 100 may permit an authority on behalf of users and to make payment orders 136, based on chains determined with algorithm 118.

Credit clearance system 100 may reduce problems of interdependent credit deadlocks by creating a central collection point for payables, receivables and limits data. From that data, credit clearance system 100 to determine zero-sum chains 126 that allow parties to pay payables to creditors with payments collected on receivables from debtors. Credit clearance system 100 may identify opportunities to create diversification of receivables and credit risk to reduce systemic risk within group limits and credit limits defined by users. Credit clearance system 100 may provide governments and central banks with better mechanisms to distribute cash injections into an economy with improved leverage and multiplier effect. Credit clearance system 100 may provide mechanisms for early payment of receivables at an appropriate discount. Credit clearance system 100 may determine present values 122 of payables and receivables with maturities to include chains. Credit clearance system 100 may issue payment orders 136 for clearance through a payment system.

### IV.B. Four Types of Chains: Zero-Sum Chains, Public Chains, Discount Chains, and Diversification Chains

Zero-sum chains 126 are chains of receivables/payables that fall in a circular chain, so that (at least the value of the smallest link in the chain) can be simultaneously resolved if a liquidity lender will lend that amount into the chain, so that each debtor can pay off the payable to the creditor, so that that creditor can in turn pay off a payable to the next creditor in the chain. Zero-sum chains 126 are discussed in § V.C.

A public chain is a chain that starts with a government entity that owes money to a private sector entity, and that private sector entity in turn owes a next entity, and so on. In a public chain, when the government pays its debt, the chain is arranged so that payment will flow from that first debtor down the chain of subcontractors and other creditors, so that the single payment frees up as much credit as possible. Credit clearance system 100 and public chains may help the government effectively distribute money to implement their policies, and maximize efficiency of each dollar spend by helping other to collect their receivables and pay their debts. Public chains are also discussed in § V.C.

Discount chain help banks to distribute credit effectively to their prime customers by using credit clearance system 100. In developing countries such as Turkey, sub-prime customers of banks cannot access bank credit. They go to factoring companies with high interest rates to discount their receivables. If they have post-dated checks in their hand, they are lucky to obtain cash by discounting the post-dated check. If their receivable is based on invoice and contract, it is very hard for them to cash out that money from factoring firms with high interest costs. They have to get consent of debtor with a maturity date. Discount chains provide a more-favorable way to resolve credit chains, and are discussed in § V.E.

Diversification chains assist lenders specifically and an economy in general in optimizing distribution of credit and debt. Some use of credit tends to help lubricate an economy, some tends to lock it up. When credit is overcommitted to a few borrowers, or over-extended in a geographical or industry sector, an economy may forego opportunities. Diversification chains identify where credit deployment is less than optimal, arranges retirement of ineffective loans, and arranges loans that can improve economic flow. Borrowers and lenders pre-authorize the creation of loans, and by computer those loans are arranged automatically. Diversification chains are discussed in § V.D.

Four chains above can be solved through graph algorithms, linear programming algorithms, and/or max-flow / min-cut algorithms, for example, shortest path and constrained optimization algorithms. Network algorithm gives individual users with a starting user and an end user in a chain the minimum matching amount in the chain. Linear programming gives total inflow to a user from other users and total outflow from the user to other users. Credit clearance system 100 may segregate this inflow and outflow to chains this solution similar to network algorithm.

### IV.C. Parties

### IV.C.1. Software Used by Users

Credit clearance system 100 may be implemented via Application Programming Interfaces (APIs) from Enterprise Resource Planning (ERPs) programs of their users such as governments, central banks, central counterparties, automated clearing houses (ACH), banks, companies and chambers of commerce and manufacturers. Developers of Enterprise Resource Planning (ERPs) programs such as Oracle, SAP, third party developed ones and internally developed ones has modules for payables and receivables. They even extend their services for credit risk and liquidity risk management due to payables and receivables. Similarly, QuickBooks and similar accounting systems allow businesses to track receivables and payables. Credit clearance system 100 may operate via an API that allows it to find payables and receivable in various ERP and accounting systems and collect them into a database, to allow users to participate in credit resolution.

### IV.C.2. Liquidity Lender

The liquidity lender may be a government entity, a central counterparty, or a bank that can profit from short-term, low-risk loans. Public entities have programs as a part of monetary policy, fiscal policy, transfer expenses and social policies. Credit clearance system 100 may help public entities to coordinate and improve effectiveness of various programs. In some uses of credit clearance system 100, a liquidity lender may make a short-term loan to a party, and those funds may flow through a chain identified by algorithm 118.

### IV.C.3. System Operator 800

System Operator 800 is the entity that operates credit clearance system 100. System Operator 800 manages payment orders with no direct financial risk, somewhat like a post office delivering checks through the mail with no direct financial risk. Once users communicate their receivables and payables into database 100, credit clearance system 100 may run algorithm 118 to find various chains. Once a chain is identified, credit clearance system 100 may pass the first party’s account destination information (typically a routing number or SWIFT BIC, and account number, or perhaps an escrow account number, see § V.F.3 below), to a liquidity lender. The liquidity lender/provider is an entity that has legal, financial, and operational capacity to give short term loans. System Operator 800 or one of the users in the chain may also be a liquidity provider. The liquidity lender makes funds available, and credit clearance system 100 executes a payment order to move the funds to the first user in the chain. Then credit clearance system 100 issues a series of executions for each link in the chain. At each link,
a payment order from link i to link i+1 in the chain
an instruction to user i’s accounting system to retire the payable as paid
an instruction to user i+1′s accounting system to retire the receivable as received
At the end of the chain, credit clearance system 100 returns the money to the liquidity lender, and instructs all users in the chain to retire the receivable and payable from their accounting systems.

System operator 800 may be any party that isn’t conflicted. System Operator 800 may be a central bank, bank, company, government entity, chamber of commerce/industry association, or a payment system.

### IV.C.4. Primary Users

Primary Users are users such as banks, central banks, public sector entities, governments and central counterparties due to their capacity to enter significantly high numbers of payment orders for receivables, payables, and limits. They follow strict rules and regulations and inform their customers regarding receivables, payables, and limits. Their customers try to meet their liabilities. Otherwise, they have additional powers on their customers. Additionally, Primary Users are major debtor and creditors in the economy. Credit clearance system 100 may help them and their customers collectively meet their liabilities.

Credit clearance system 100 may give priority to Primary Users to collect their receivables, pay their debts and meet their limits constraints before other users in algorithm 118. Furthermore, credit clearance system 100 may set a hierarchy among users in algorithm 118. There are many data input from users, banks, public, and central counterparties. Credit clearance system 100 may give incentives to those parties to give priority their payments and collections. Priority Index is the one tool in credit clearance system 100 to make this differentiation. Above this, credit clearance system 100 puts another layer of priority named hierarchy for batches. The hierarchy for batches allows additional priority for resolution of primary users’ payables and receivables. For example, the first batch may run datasets of user and public. The second batch may be residual from the first batch and datasets of banks. The third batch may be residuals from the second batch and datasets of central counterparties. The fourth batch may be residuals from the third batch and available limits of Group companies. The fifth batch may be residuals from the fourth batch and available limits of other Firms. Also, batching in this way may reduce computational complexity. For example, in Turkey, there are 500,000 companies. This means matrices of 500,000 × 500,000. If individuals may join credit clearance system, the number may be much higher, with corresponding growth of data storage and computational complexity.

FIG. 3 shows comparison of central counterparties and credit clearance system 100 as an example. Traditional central counterparties determine Net Payments that users have to pay or receive, and collect and pay net payments. Central counterparties are exposed to credit risks and hold collateral to mitigate risks. The three transfers require a total of $350 of liquidity. Users generally hold this amount of money for two days, practically one day for making money available for payment and the next day for transferring to their counterparties’ account. Users hold excessive cash to meet payments on time. Central counterparties may be able to reduce the amount of money ($350) needed by offsetting payments. Central counterparties calculate sum of payments of each user as Total (From), sum of receipts of each user as Total (To) and Net Payments as difference between Total (To) and Total (From). Central counterparties inform their users and collect net payments (e.g., $20 from user 872 and $10 from user 873) and pay $30 to user 871 by holding their collateral to cover risk. In contrast, algorithm 118 of credit clearance system 100 may identify a zero-sum chain 126 and the minimum amount of any link in the chain ($100) with constraints and amounts transferred. The residual amounts ($10, $20, and $30) after execution and settlement of the chain are the separate responsibility of users. Therefore, credit clearance system 100 may eliminate or reduce the initial liquidity and collateral required to clear the three payables.

Furthermore, central counterparties may enter Net Payments of their customers into credit clearance system 100. In the example, central counterparties may enter data to collect $20 and $10 from users 872 and 873 to pay $30 to user 871. Credit clearance system 100 may pay $100 to each customer in the zero-sum chain 126 and the residual amounts ($20 and $30) may be left responsibility of user 872 and user 873.

Likewise, every day, banks give loans to their customers and collect repayment of loans. In this process, banks have three major challenges: funding, holding regulatory capital, and allocating loans among their customers. Credit clearance system (CCS) 100 may help them to overcome these challenges by using payables of their customers. Banks may announce to their customers that they will give loans to fund payment orders of their prime customers (customers with high credibility) as a product (i.e. CCS loans). Banks may enter loan limits for their prime customers and enable their sub-prime customers (customers with low credibility) to pay their outstanding loans/ payables (low rating and possibly delinquent). Banks may also encourage their customers to enter into a database 110 operated by credit clearance system 100 their payables and authorization to initiate payment orders. Each payment order has its designated recipient counterparty (name and routing/account number), amount, and any memorandum note. Algorithm 118 of credit clearance system 100 finds optimal zero-sum chains 126 and amounts out of the database 110, and banks may then extend credit to prime customers within their credit limits, create necessary funding from the collection of sub-prime customers, and hold less regulatory capital (i.e. less provisions for non-performing loans) by allocating credits to prime customers.

Similarly, database 110 and algorithm 118 of credit clearance system 100 may assist governments in funding their payment obligations and in collecting taxes and other receivables. Government entities as users enter their payables and receivables into credit clearance system 100. Algorithm 118 analyzes database 110 to find zero-sum chains 126. Credit clearance system 100 identifies the lowest amount of any link in a zero-sum chain 126, and arranges payment orders 136. Governments may offer improved fee handling or otherwise incentivize or require citizens/entities to enter their payment data into credit clearance system 100 in order to collect their receivables from government earlier, and to discipline users to pay their payables to each other on time.

As banks and governments benefit credit clearance system 100, they may encourage and support users to enter more payment orders due to payables and advance payments into credit clearance system 100. Users may use credit clearance system 100 as a risk management tool for their payables and receivables as part of their ERPs. Users can increase the likelihood of collecting their receivables by entering more of their receivable and payables into credit clearance system 100. Users may communicate with their counterparties to urge them to enter payables and receivables into credit clearance system 100. Users may inform their counterparties that they can pay their payables with collections of receivables through credit clearance system 100. Credit clearance system 100 may improve the collection rate and collection speed of receivables.

Referring to FIG. 4, credit clearance system 100 may help users to diversify their short-term credit and liquidity risks by using diversification chains 124. Credit limits are set by lenders or payees per borrower, debtor, or payor to cap the credit that the lender/payee will extend to the borrower/debtor/payor as a matter of business risk management. A credit limit extended to an unrelated firm is called a Firm Limit. Group Limits means credit limits that users define for lending to their own intra-enterprise corporate parents, sisters, and subsidiaries. Credit clearance system 100 may run algorithm 118 in a first pass to clear receivables and payables of users. As a second pass, credit clearance system 100 may runs algorithm 118 to identify receivables from others to users within the Group Limit. As a third pass, credit clearance system 100 may run algorithm 118 to find diversification chains 124 (see § V.D) to identify better systemic balances of receivables/payables to increase likelihood of collection.

Credit clearance system 100 may help users to diversify and reduce their credit risk and liquidity risks by using those limits in database 110 and algorithm 118 to determine diversification chains 124 (see § V.D). Credit clearance system 100 may calculate recommended changes after optimizing receivables within firm limits of related counterparties. Credit clearance system 100 includes available limits to payment directed graph 114 and uses algorithm 118 to determine diversification chains 124. Credit clearance system 100 helps users to collect receivables from other users to pay payables of companies within firm limits. In the example of FIG. 4, user 820 has receivables (including available limits) and has defined available limits to other users in the System. User 820 has receivables of $130 from user 811. User 811 has receivables of $80 and $20 from user 815 and user 816 respectively. User 815 and user 816 have receivables of $110 and $120 from user 812 and user 813 respectively. Credit clearance system 100 determined for user 820 has available limits of $80 and $80 to user 812 and user 813 respectively. System Operator 800 determines diversification chains 124 with inclusion of Available Limits. In this example there are two diversification chains 124. The first chain is user 820-> user 812-> user 815-> user 811-> user 820 with the minimum amount of $80. The second chain is user 820-> user 813-> user 816-> user 811-> user 820 with the minimum amount of $20. Therefore, user 820 has diversified it receivables to 3 users and reduced its credit and liquidity risk by optimizing the throughput network value 120 of receivables.

Referring to FIG. 5, governments and central banks from time to time give cash to support trade and economic activity (for example, stimulus packages) within the scope of fiscal and monetary policies. Credit clearance system 100 may help governments to increase effectiveness of their policies. Governments may enter their payables to their citizens/entities into credit clearance system 100. Additionally, governments may enter cash amounts to distribute and beneficiary users that governments want to give cash. Beneficiary users may be any user that governments want to support for any reason. Credit clearance system 100 may determine public chains 128. With the minimum amount that government entities pay their payables to users (user 817) and leave cash in accounts of beneficiary users (821). Public chain (i.e. 816-> user 817-> user 818-> user 819-> user 820 -> user 821) also supports others (i.e. user 808) and their economic activity by paying their payables with collections of their receivables.

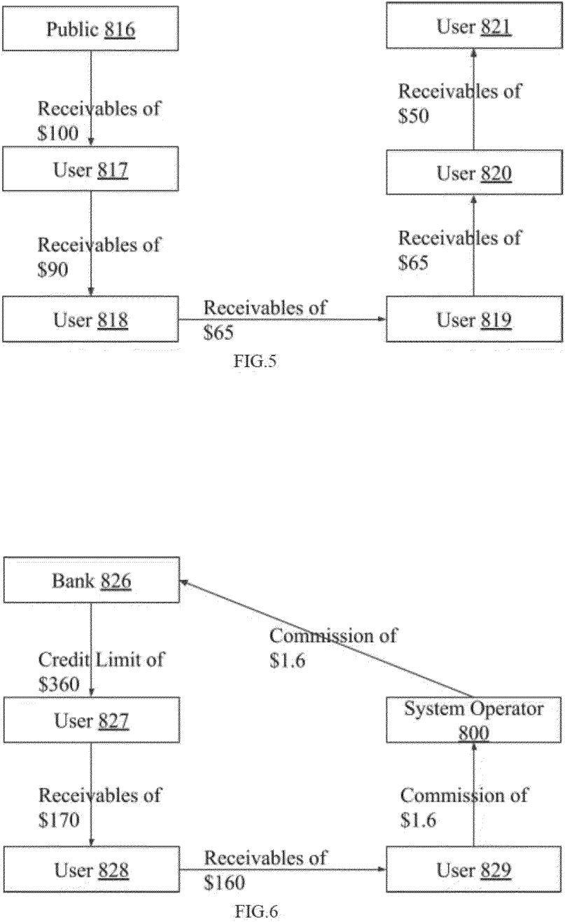

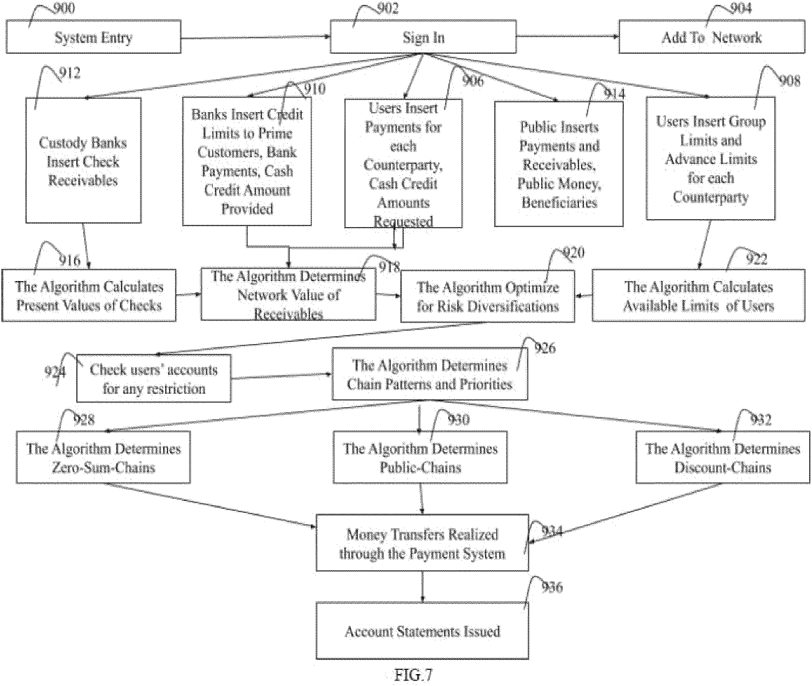

Referring to FIG. 6, credit clearance system 100 shows how to create discount chains using the database 110. Discount chain 130 means a chain of users matching credit requesting users and credit providing users with a flat fee. The existing credit market has deadlocks. Banks can not extend credits to sub-prime customers because of their low credit ratings, risk averseness and market conditions. Also, banks can not extend credits to prime customers because of their unwillingness to borrow with current rate. Those prime customers also unwilling to pay their debt on time due to their market power. Credit clearance system 100 helps banks, prime customers and sub-prime customers to match their expectations in a market structure. This is a similar methodology used by Uber to commuting market to increase the efficiency. By using discount chain 130, banks may use credit clearance system 100 to give cash credit to users (their prime customers) and leave the money in accounts of users willing to pay a flat rate commission (for example, 1%) predetermined by credit clearance system 100. Credit clearance system 100 collects this flat rate commission from their escrow accounts of users and pays to banks as commission incomes. Banks generally have established credit limits for their prime customers, and may enter them into credit clearance system 100. Banks enter the cash credit amount to provide users by taking into account the flat rate commission. Users enter the cash credit amount requested to collect their receivables with flat rate commission. Credit clearance system 100 determines discount chains with the minimum amount that the bank 826 give credits to the user 827 as prime customers and leave the cash money in the escrow account of the discounting user 829 who accept to pay a flat commission (i.e. 1%). User 829 is a sub-prime customer for banks and it is unable to borrow from banks. Therefore, user 829 is willing to discount its receivable by paying a flat commission to the system. For user 829, paying flat commission to collect its receivable from 828 is effectively a discounting. The lending bank (user 826) reduces its prime rate in order to incentivize its prime customer (user 827) to borrow which is effectively a discount on interest receivable. Since there are two types of discount in this chain, it is called discount chain. The lending bank compensates its discounted interest earning from prime customer by collecting flat commission from sub-prime customer for the loan extended to prime customer. Discount chain 130 (i.e. 826-> user 827-> user 828 -> user 829) also helps the other user 828 to pay their payables with collections of receivables. System Operator 800 collects the flat rate from the last user in the chain and returns to the bank 826. Bank 826 lends its prime customer User 827 $160 at a discounted interest rate within the credit limit of $360 and collects predetermined 1% flat commission of $1.6 from User 928 through System Operator 800. Discount chains 130 named with discount to refer the amount of flat commission to be paid to banks due to receiving cash collection by means of bank credit indirectly.

In some countries such as Turkey, post-dated checks are used as a payment tool with maturities. Payees generally submit these checks to banks for custody and clearance at maturity, or as collateral on loans. Banks holding post-dated checks as collateral carry the credit risk of issuers; this credit risk depends on performance by the issuer to pay the full amount at maturity date. Credit clearance system 100 may increase liquidity and decrease risk for post-dated checks held by banks, if the banks enter post-dated checks they hold into credit clearance system 100. Credit clearance system 100 may calculate the present value 122 of the checks’ notional amount to include them into algorithm 118 and determines the amount cleared through chains. The remaining balance may be carried to the future value at maturity by reverse formula of present value 122. This process continues until maturity or the present value 112 of notional amount is zero. When the maturity date comes, any remaining difference between notional amount and money previously transferred may be reconciled as a difference payment among users as interest income for payers and interest expense for receivers of checks. Market practices may require users to have maturities for payables and receivables and to reimburse interest due to early payment of debts. Credit clearance system 100 may include maturities for payables and receivables and use the calculation of present value 122 a part of algorithm 118.

Credit clearance system 100 may be implemented as a stand-alone system on an individual basis or part of a more general system, such as central banking, banking system or payment system.

### V. Implementation Via a Database

Referring to FIG. 7, users join into credit clearance system 100 with the process of System Entry 900. Users enter credit clearance system 100 with the process of Sign-in 902. Users add other users into their network by using the process of Add to Network 904. Users insert their payment orders for each counterparty and their cash credit amount requested 906. Users insert their Group Limits and Firm Limits for each counterparty 908. Banks insert their Credit Limits and their receivables for each counterparty and their cash credit amount provided 910 to their users. Custody Banks insert data of check receivables 912. Public entities insert their payables and receivables as payment orders 914. Algorithm 118 calculates present values of checks 916, directed graph values of receivables 918, available limits of users 922 and optimize risk diversification 920. Algorithm 118 determines chain patterns and priorities 926, zero-sum chains 928, public chains 930, and discount chains 932. System Operator 800 issues payment orders and issues account statements 936.

### V.A. Database Structure

A database 110 for a credit clearance system 100 may include the following tables:

| | |
|---|---|
| Table Name | Data Included |
| SystemEntry 212 | stores information regarding Users |
| SignIn 214 | stores information regarding sign in of users and their authorized persons |
| MyNetwork 216 | stores network of users |
| Payables 218 | stores information regarding amount to be paid to other users with notes/explanation |
| GroupLimits 220 | stores information regarding amount of limit assigned to other users within their groups (i.e. sister companies, partners with close relationships) |
| FirmLimits 222 | stores information regarding amount of limit assigned to other users (i.e. business partners) |
| BankPayments 224 | stores information that banks enter amount to be paid by users with notes due to banking activities |
| BankLimits 226 | stores information regarding amount of credit limit that banks assigned to other users |
| CCProvided 228 | stores information that banks enter amounts provided as cash credit due to banking activities with a flat rate of commission determined by System Operator 800 |
| CCRequested 230 | stores information that users enter amounts requested as cash credit with a flat rate of commission determined by System Operator 800 |
| CCommisions 232 | stores information that System Operator 800 enters a flat rate of commission for calculation of commission collected from requesting users and providing bank users |
| Checks 234 | stores information that Custody Banks enter amount to be paid between counterparties with check numbers |
| PublicPayments 236 | stores information that public entities enter amount to be paid to other users with notes due to public activities |
| PublicReceivables 238 | stores information that public entities enter amount to be collected from other users with notes due to public activities |
| Beneficiaries 240 | stores information that public entities enter beneficiary users due to public activities |
| PublicMoney 242 | stores information that public entities enter public money available for distribution due to public activities |
| Table CCPPayments 244 | stores information that central counterparties enter amount to be paid to other users with notes due to CCP activities |
| Table CCPReceivables 246 | stores information that central counterparties enter amount to be collected from other users with notes due to CCP activities |
| InterestRates 248 | stores information that System Operator 800 enters interest rates receivables and payables from checks |
| Table InterestCalculation 250 | stores information that credit clearance system 100 calculates interest and discounted values of checks |
| Table CashFlow 252 | stores information that System Operator 800 cash flows of checks |
| Table LedgerHistory 254 | stores result of calculations “who to whom”, amount, balances, chain numbers etc to track |
| Table PathLog 256 | stores path of users in chains with amount based on LedgerHistory |
| Table Ledger 258 | stores balance of payables for users based on LedgerHistory |
| Table Statements 260 | stores information that System Operator 800 transferred amounts from accounts of users |
| Table TransferOrder 262 | stores information that System Operator 800 sends to the payment system so that money transfers realized through accounts |

Table SystemEntry 212

| | | |
|---|---|---|
| Field | Type | Data Included |
| UserID | text | Unique ID for user such as Tax ID, Social Security etc |
| Name | text | Company Name, Individual name etc |
| Password | text | User password to enter the System |
| PaymentAccounts | text | the account that is to be sent out of credit clearance system due to discount chains and public chains |

Table SignIn 214

| | | |
|---|---|---|
| Field | Type | Data Included |
| UserID | text | Unique ID for user such as Tax ID, Social Security etc |
| Email | text | alternate emails to enter data into the System |
| Roles | text | Email roles, such as admin, bank, public etc |

Table MyNetwork 216

| | | |
|---|---|---|
| Field | Type | Data Included |
| UserID | text | User selects from System Entry Table with UserID |

Table Payables 218

| | | |
|---|---|---|
| Field | Type | Data Included |
| PaymentFrom | text | UserID that inserts payment data |
| PaymentTo | text | User selects from System Entry Table with UserID. |
| Amount | number | Payable amount |
| Notes | text | Payment note/explanation |

Table GroupLimits 220

| | | |
|---|---|---|
| Field | Type | Data Included |
| LimitFrom | text | UserID that inserts group limit data |
| LimitTo | text | User selects from System Entry Table with UserID |
| Amount | number | Limit amount defined to user |

Table FirmLimits 222

| | | |
|---|---|---|
| Field | Type | Data Included |
| LimitFrom | text | UserID that inserts firm limit data |
| LimitTo | text | User selects from System Entry Table with UserID. |
| Amount | number | Firm Limit amount defined to user |

Table BankPayments 224

| | | |
|---|---|---|
| Field | Type | Data Included |
| PaymentFrom | text | User with banking roles selects from System Entry Table with UserID. |
| PaymentTo | text | UserID with banking roles that inserts payment data |
| Amount | number | Payable amount |
| Notes | text | Payment note |

Table BankLimits 226

| | | |
|---|---|---|
| Field | Type | Data Included |
| LimitFrom | text | UserID with banking roles that inserts bank limit data |
| LimitTo | text | User selects from System Entry Table with UserID. |
| Amount | number | Bank Limit amount defined to user |

Table CCProvided 228

| | | |
|---|---|---|
| Field | Type | Data Included |
| UserID | text | User as bank roles entering data to the table |
| Amount | number | Cash credit to be paid to users as customers |
| DistributionDate | Date | the date cash credit available for distribution |

Table CCRequested 230

| | | |
|---|---|---|
| Field | Type | Data Included |
| UserID | text | Users as bank customers entering data to the table |
| Amount | number | Cash credit requested by users as customers |
| DistributionDate | Date | the date cash credit requested |

Table CCommission 232

| | | |
|---|---|---|
| Field | Type | Data Included |
| CommissionRate | number | Commission rate to be used for cash credit entered by System Operator 800 |
| DistributionDate | Date | the date cash credit requested |

Table Checks 234

| | | |
|---|---|---|
| Field | Type | Data Included |
| CustodyBank | text | UserID that inserts custody checks’ data |
| CheckFrom | text | User selects from System Entry Table with UserID. |
| CheckTo | text | User selects from System Entry Table with UserID. |
| CheckAmount | number | Amount written on the check |
| Maturity | date | Maturity date written on the check |
| CheckNumber | text | Check number written on the check |

Table PublicPayments 236

| | | |
|---|---|---|
| Field | Type | Data Included |
| PaymentFrom | text | UserID that inserts public payment data |
| PaymentTo | text | User selects from System Entry Table with UserID. |
| Amount | number | Payable amount |
| Notes | text | Payment note |

Table PublicReceivables 238

| | | |
|---|---|---|
| Field | Type | Data Included |
| ReceivablesFrom | Text | User selects from System Entry Table with UserID. |
| ReceivablesTo | Text | UserID that inserts receivables data |
| Amount | number | Receivable amount from users |
| Notes | Text | Receivable note |

Table Beneficiaries 240

| | | |
|---|---|---|
| Field | Type | Data Included |
| BeneficiaryTo | Text | User selects from System Entry Table with UserID. |

Table PublicMoney 242

| | | |
|---|---|---|
| Field | Type | Data Included |
| UserID | text | User selects from System Entry Table with UserID. |
| Amount | number | Public money to be paid to beneficiaries |
| DistributionDate | Date | the date money available for distribution |

Table CCPPayments 244

| | | |
|---|---|---|
| Field | Type | Data Included |
| PaymentFrom | text | UserID that inserts CCP payment data |
| PaymentTo | text | User selects from System Entry Table with UserID. |
| Amount | number | Payable amount |
| Notes | text | Payment note |

Table CCPReceivables 246

| | | |
|---|---|---|
| Field | Type | Data Included |
| ReceivablesFrom | text | User selects from System Entry Table with UserID. |
| ReceivablesTo | text | UserID that inserts receivables data |
| Amount | number | Receivable amount from users |
| Notes | text | Receivable note |

Table InterestRates 248

| | | |
|---|---|---|
| Field | Type | Data Included |
| CalculationDate | text | User selects from System Entry Table with UserID |
| InterestRate | number | Interest rate used for calculation of present values for amounts with maturities inserted by System Operator 800 |

Table InterestCalculation 250

| | | |
|---|---|---|
| Field | Type | Data Included |
| CalculationDate | text | User selects from System Entry Table with UserID |
| InterestRate | number | Interest rate used for calculation of present values for amounts with maturities inserted by System Operator 800 |
| CheckNumber | text | Check number written on the check |
| Maturity | date | Maturity date written on the check |
| CheckAmount | number | Amount written on the check |
| PVAmount | number | Discounted value of amount written on the check or remaining balance with interest rate of calculation date |
| trx_amnt | number | an amount a user (from) paying to another (to) in a chain |
| RemainingBalance | number | amount after trx _amnt deducted from PVAmount |
| FVRemainingBalance | number | Future value of amount of RemainingBalance with interest rate of calculation date at Maturity date |

Table PathLog 256

| | | |
|---|---|---|
| Field | Type | Data Included |
| path_literal | text | listed in a format of all paying users to receiving users (from->to) for every chain created |
| trx_amnt | number | an amount a user (from) paying to another (to) in a chain |
| iter_type | text | zero-sum chain or Public chain |
| Iteration | number | an iteration number generated sequentially in the process |
| Batch | number | a batch number generated sequentially within iteration in the process |
| all_hops_median | number | a median number for receivables used for the calculation of Network Value |
| hop1_total | number | a network value of receivables used for the calculation of Network Value |
| network_value_Ratio | number | a payable or receivable amount before trx_amnt deducted |

Table LedgerHistory 254

| | | |
|---|---|---|
| Field | Type | Data Included |
| iter_type | text | zero-sum chain or Public chain |
| Iteration | number | an iteration number generated sequentially in the process |
| Batch | number | a batch number generated sequentially within iteration in the process |
| Start | text | a user that starts a chain |
| End | text | a user that ends a chain |
| From | text | a user paying an amount a chain |
| To | text | a user receiving an amount a chain |
| trx_amnt | number | an amount a user (from) paying to another (to) in a chain |
| prev_balance | number | a payable or receivable amount before trx_amnt deducted |
| curr_balance | number | a payable or receivable amount after trx_amnt deducted |
| all_hops_median | number | a median number for receivables used for the calculation of Network Value |
| hop1_total | number | a network value of receivables used for the calculation of Network Value |
| network_value_Ratio | number | a network value (hop 1_total)/total amount of receivables |

Table CashFlow 252

| | | |
|---|---|---|
| Field | Type | Data Included |
| TransactionNumber | number | Number to follow the tractions |
| FromUsers | number | Public money to be paid to beneficiaries |
| ToUsers | number | Check number written on the check |
| CFAmount | number | Amount of cash flow at the beginning |

Table Balance 258

| | | |
|---|---|---|
| Field | Type | Data Included |
| Debtor | text | a paying user |
| creditor | text | a receiving user |
| balance | number | an amount left as a balance after iterations |

Table Statements 260

| Field | Type | Data Included |
|---|---|---|
| FromTo | text | User selects from System Entry Table with UserID |
| Amount | number | Receivable amount from and paid amount to users |
| Notes | text | Note from users inserted for the payment |
| Table TransferOrder 262 | | |
| Field | Type | Data Included |
| OrderNo | number | The number of order to be followed for the money transfer |
| From | text | Account number of user sending money to counterparty (To) |
| To | text | Account number of user receiving money from counterparty (From) |
| Amount | Number | Receivable amount from and paid amount to users |
| Notes | Text | Note from users inserted for the payment |

### V.B. Data Entry

Credit clearance system 100 is initially designed for an auction market. Credit clearance system 100 runs algorithm 118 to determine chains. A human may review the computation to ensure that the computed chain is sound. While algorithm 118 is running (typically in batch-run times), credit clearance system 100 may lock users’ data entries and accounts. Users can revoke or change their entries at any time before or after batch-run times as credit clearance system 100 allows. Credit clearance system 100 may allow users to enter new data during this time and put them into a separate database for the next run. Credit clearance system 100 may be programmed for the Continuous Market based on users’ behavior and the market structure. In this case, algorithm 118 runs automatically to find chains after users enter new data.

Parties may be incentivized to enter their receivables and payables into credit clearance system 100 by a number of mechanisms. If governmental entities load all payables into the credit clearance system 100, parties may be incentivized their government receivables, in order to be paid sooner. As more users load receivables and payables, other users may be incentivized to take advantage of a central payment and clearance system.

This is a systemic problem and like Nash-Equilibrium. In Turkey, business practice tried to come over this problem by using post-dated checks. Although checks are legally a payment order at sight, in Turkey, post-dated checks are used as a kind of money by transferring as payment tool. It is better for government to set up such a system and incentivize citizens/entities to feed their payables and receivables data. Credit clearance system 100 may be implemented as an extended automated clearing house (ACH), by adding a value date to ACH transaction messages. Payment orders in such a system may create a payment directed graph 114 with many zero-sum chains 126. Users may handle residual payments with banks transfer or ACH as usual. The current ACH focuses the speed of money transferred among the accounts of banks; in contrast, credit clearance system 100 focuses on the time difference between the invoice accepted by counterparty and the payment completed, and introduces a solution to shorten the time gap. Furthermore, a current problem in U.S. is that credit channels do not work properly to address market needs, even when money is printed and circulated with stimulus packages.

A major bank with a large customer base may incentivize its customers. Current credit risk models are focused on long term (over 1_year) viability of business. They use standard risk models and same credit ratings as benchmark to validate them. However, businesses around world always take short term credit risk with each other. The party with higher credit worthiness or trust generally requires its counterparty to bear the credit risk. The timing of invoices and payment rarely happens simultaneously. Banks can use credit clearance system 100 to manage their short-term credit risk and help their customers to pay their debts with collections from their receivables.

Payment systems such as Novi, Google Pay, and Apple Pay are becoming centers of global payment systems. They can collect money (deposit) and transfer money as an alternative to bank payment systems. Credit clearance system 100 may help payment systems, banks, and customers to manage their credit risk and liquidity risk.

Businesses (either local or global) may take advance payments from their customers by using credit clearance system 100. Businesses may issue loyalty cards within a wallet such as Google wallet or Novi and give customers discount as Starbucks does. Customers of a business may pay to their loyalty cards with their receivables a part of their chain. Customers as users may enter payables to credit clearance system 100. Credit clearance system 100 finds relevant chains to do payments of loyalty cards. Businesses may pay their payables with its collection from loyalty card payments a part of the relevant chains. Customers may use credit in the loyalty card for their payment.

Credit Clearance system 100 may permit users to define whom and how much they trust counterparties by setting Group Limits and Firm Limits.

Users may enter data into various tables of database 110, including Table SystemEntry 212. Credit clearance system 100 defines additional emails and their roles for authorized persons of users in Table SignIn 214. Users may add other users into their network to be stored in the Table MyNetwork 216. Users may insert counterparties, amounts and notes of their payments to be stored in the Table Payables 118. Users may insert counterparties and amounts of their Group Limits to be stored in the Table GroupLimits 220. Users insert counterparties and amounts of their Firm Limits to be stored in the Table FirmLimits 222.

Users with banking roles may insert counterparties, amounts and notes of their banking payments to be stored in the Table BankPayments 224. Users with banking roles insert counterparties and amounts of their banking limits to be stored in the Table BankLimits 226.

Users with banking roles may insert amounts provided for total cash credit to users as their prime customers to be stored in the Table CCProvided 228. Users insert amounts requested as cash from their receivables to be stored in the Table CCRequested 230. System Operator 800 inserts flat commission rate for cash credits provided and cash requested to be stored in the Table CCRequested 232.

Users with banking roles may insert counterparties, check amounts, maturities and numbers of checks under their custody to be stored in the Table Checks 228.

Users with public roles may insert counterparties, amounts and notes of their public payments to be stored in the Table PublicPayments 236. Users with public roles insert counterparties and amounts of their public receivables to be stored in the Table PublicReceivables 238. Users with public roles insert beneficiary users to be stored in the Table Beneficiaries 240 so that they can have cash in their accounts for their receivables. Users with public roles insert cash amounts to be stored in the Table PublicMoney 242 so that credit clearance system 100 can distribute public money among other beneficiary users.

Users with central counterparty roles insert counterparties, amounts and notes of their central counterparty payments to be stored in the Table CCPPayments 244. Users with central counterparty roles insert counterparties and amounts of their central counterparty receivables to be stored in the Table CCPReceivables 246.

Credit clearance system 100 may include buttons to delete, to change, to insert data. Credit clearance system 100 may provide functionalities for user friendly entries data such as sending links for approval of their counterparties. Based on market structure and users’ needs, Credit clearance system 100 may enforce that some data are irrevocable, and other data may be edited by users. For irrevocable data, for example payments, credit clearance system 100 may require both parties’ approval and allows only receiving users to delete.

### V.C. Calculation of Zero-Sum Chains

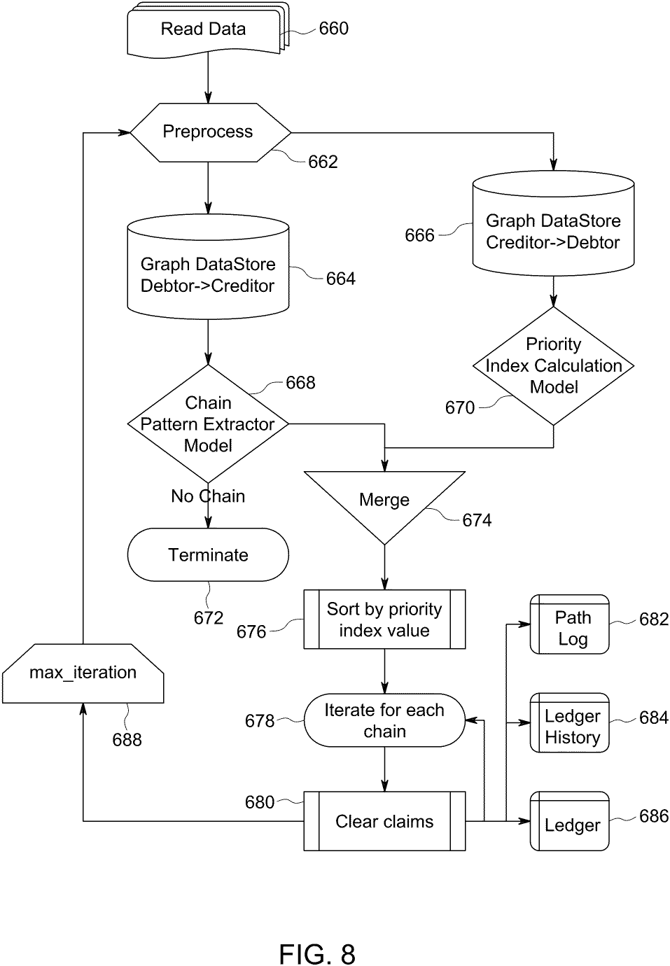

FIG. 8 illustrates the process of determining zero-sum chains 126. Algorithm 118 uses the dataset of Payables of users as Transaction Data to collect the money from payors (i.e. banks, public sector entities, central counterparties) by giving money to payees. Credit clearance system 100 may use a hierarchy of Primary Users, i.e., banks, public, central counterparties, available amounts of group limits, available amounts of firm limits etc. Credit clearance system 100 may run several times to find most-preferred chains down to less-preferred chains. For instance, a first run of algorithm 118 may search database 110 to find zero-sum chains 126 that have at least one public sector entity. A second run of algorithm 118 may search database 110 for zero-sum chains 126 that have at least one bank. A third run of algorithm 118 may search database 110 for zero-sum chains 126 that have at least one central counterparty. The forth batch will be remaining data of previous batch and data of available limits of Groups in database 110. The fifth batch will be remaining data of previous batch and data of available limits of Firms in database 110. The first three batches are used to clear receivables and payables of users. However, Group Limits allows users to swift receivables from other to users within Group Limits. Firm Limits allow users to transfer receivables from other to users within Firm Limits with optimal diversification.

In some cases, it may be desirable to identify a chain that is not a closed cycle but rather that ends with a specific user, so that an initial payment into the chain lodges with various parties and the last user in the chain. In some cases, it may be desirable that various amounts “stick” to various parties: for example, the first payable/receivable pair may be that the government owes $100, the second may be $90, the third $65, the fourth $65, and then the fifth $50 as shown FIG. 5. Government pays $50 to the first one and everybody in the chain pays their debt and gets their receivables and leaves the parties with the residuals of $50 ($100-$50), $40 ($90 - $50), $15 ($65 - $50), $15 ($65 - $50) and $0 ($50 - $50), respectively. Examples of this kind of chain might arise where the first payor is a government entity, and for public policy reasons, it is desirable to inject capital to the parties in the chain. In traditional economic stimulus programs, government simply hands each party a check. By running that same amount of money through a chain of credit clearance system 100, the stimulative effect of that same capital injection may be considerably larger, because users in the chain benefit from both the residual money that was left with them, plus the relief of payable obligations. This may be especially valuable in developing countries, where credit deadlocks may originate when government postpones payment to its vendors and payees (In Turkey sellers to government wait up to 1 year to get paid from government). Government may react by adopting social programs to distribute funds to beneficiaries, which leads to double spending. By using this chain mechanism, lesser fund amounts may have greater stimulative effect. Public users insert Public Money (PublicMoney) into credit clearance system 100, credit clearance system 100 runs to determine Public chains 128. Credit clearance system 100 uses algorithm 118 and determines directed routes from the Public user 806 to the Beneficiary user 821 with the Public Chain of Public user 816-> user 817-> user 818-> user 819-> user 820-> user 821 in FIG. 5.

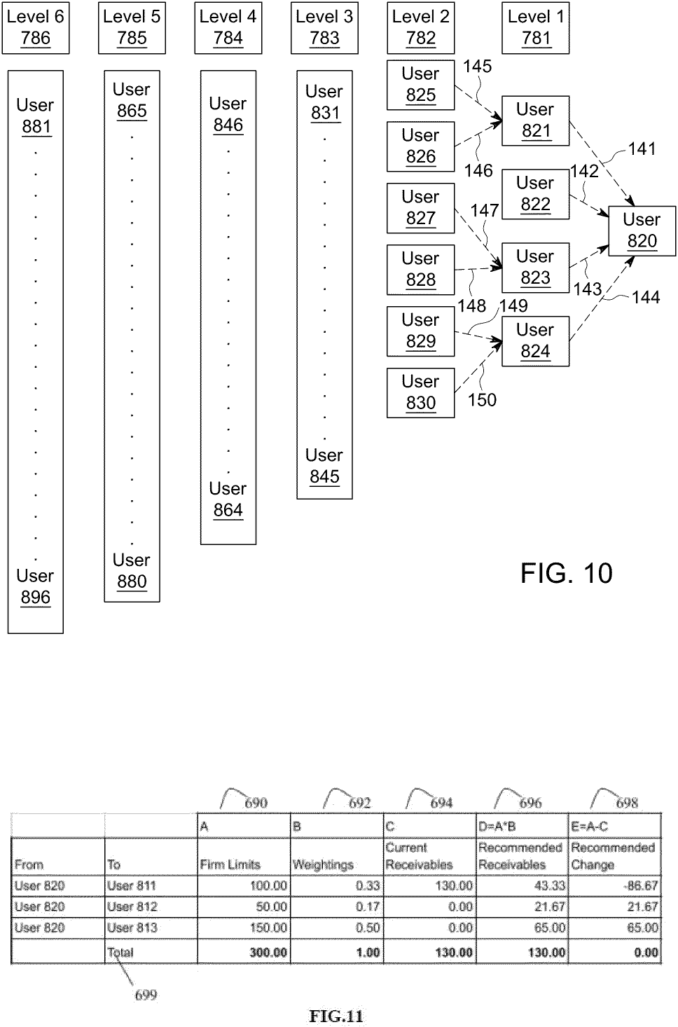

Algorithm 118 reads the database 110 to be stored in the Table CashFlows 252 with the dataset of TransactionNumber, FromUsers, ToUsers, and CFAmount. Amounts in this table (CFAmount) is the amount in the Table Payables 218, BankPayments 224, BankLimits 226, PublicPayments 236, PublicReceivables 238, CCPPayments 244 and CCPReceivables 246. System Operator 800 will take into account available amounts of GroupLimits 220, and recommended changes of FirmLimits 222 as CFAmount of Table CashFlows 252. Available amounts are calculated as amount of GroupLimits 220 after deducting receivables from relevant party. Recommended changes are calculated by using a simplified methodology shown in FIG. 10.

Total value (TotalV) of a chain is number of flows multiplied by the minimum amount in the chain. Algorithm 118 aims to maximize sum of the total values (Total V) through the directed graph. Adding constraint having a Primary User in a chain reduces the sum of the total values (TotalV) for maximization of chains. System Operator 800 accepts this constraint to attract the Primary Users to be a part of credit clearance system 100 or to get a benefit such as commission, money etc.

Algorithm 118 is a general term to define the whole process of FIG. 8 with major outcomes or functionalities of network value 120, present value 122, Diversification chains 124, zero-sum chains 126, public chains 128 and discount chains 130. One piece of the process is “Chain Pattern Extractor Model 668”. “Chain Pattern Extractor Model 668” determines all possible chains for pair users. Pair users are from user A to user A for zero-sum chain (circular). Pair users are from user A to user N for public chain or discount chain. After merging these possible chains with the outcome (priority index value 676) of the priority index calculation model, the optimal solution is determined by sorting priority index value 676. This can be one or more chains for a pair of users (“from user A to user A” or “from user A to user B”). Priority index calculation model 670 has several inputs one of them is network value 120.

Credit clearance system 100 uses Chain Pattern Extractor Model 668 and the Priority Index Calculation Model 670 of FIG. 8. Chain Pattern Extractor Model 668 is a graph algorithm based on network models such as Floyd-Warshall (Floyd, Warshall: Algorithm 97 Shortest path, Communications of the ACM 5 (1962) 345) and Ford-Fulkerson (Ford, L. R.; Fulkerson, D. R. (1956). “Maximal flow through a network” Canadian Journal of Mathematics. 8: 399-404. doi:10.4153/CJM-1956-045-5). The Priority Index Calculation Model 670 is a function of network values 120, amount of receivables and other factors. Chain Pattern Extractor Model 668 has multiple sub-functions to solve diversification chains 124, zero-sum chains 126, public chains 128 and discount chains 130 by using graph algorithms. Chain Pattern Extractor Model 668 has extension to use optimization methodology to determine those chains.

FIG. 10 illustrates an example of network tree for calculation of network value 120. User 820 may have direct or indirect receivables (including available credit limits) from users in credit clearance system 100. User 820 has direct receivables at level 1 781 within credit clearance system 100, namely from user 821, user 822, user 823 and user 824. User 820 may have indirect receivables at level 2 782, level 3 783, level 4 784, level 5 785, level 6 786 and so on. As levels of the receivables graph increase, the likelihood of user 820 increases to have receivables from one of users in the payment directed graph 114. This is a kind of collateralization of receivables. Credit clearance system 100 calculates the network value 120 of the directed graph (^{NetworkV}ⱼ) of Receivables for user (j). Constant (^{C}_{E}) can be numbers such as 2/64, 4/64, 8/64, 16/64, 32/64 etc. Factors (a₁, a₂,..) can be weighting such as 0.60 and 0.40 etc. Also, credit clearance system 100 can add some other factors.
^{A}ₛ= Median of receivables at level of (s)
^{L}ₛ= Median of credit limits at level of (s)
ⁿₛ= Number of users at level of (s)
^{C}ₛ= Constant at level of (s)
$$N e t w o r k {V}_{j} = {a}_{1} {\sum }_{}^{} A \cdot n \cdot c + {a}_{2} {\sum }_{}^{} {L}_{s} \cdot n \cdot c + …$$

Credit clearance system 100 follows the process of network algorithms defined in FIG. 8:
a. processes 662 dataset to calculate Chain Pattern Extractor Model 668 by using Graph Data Store Debtor->Creditor 664 (from debtor to creditor), and terminate 672 the model if there is no chain exist,
b. calculates Priority Index Calculation Model 670 by inclusion of a value of the flow of receivables through the directed graph based on dataset of Graph Data Store Creditor -> Debtor 666 (from creditor to debtor),
c. selects only chains that contain at least one Primary User determined by Chain Pattern Extractor Model 668,
d. merge 674 datasets calculated by Chain Pattern Extractor Model 668 and Priority Index Calculation Model 670 and sort the dataset by priority index 676,
e. iterate for each chain 678 and clear claims 680 for this iteration,
f. updates dataset of pathlogs 682, ledger history 684 and ledger 686 to monitor results of iteration,
g. moves to the next iteration to make sure there is no chain left in the remaining dataset by setting a maximum iteration 688 number such as 10 or put a flag to terminate the process.

Credit clearance system 100 follows the process defined in FIG. 8. Chain Pattern Extractor Model 668 selects only chains that directed from Public Users to beneficiary users..

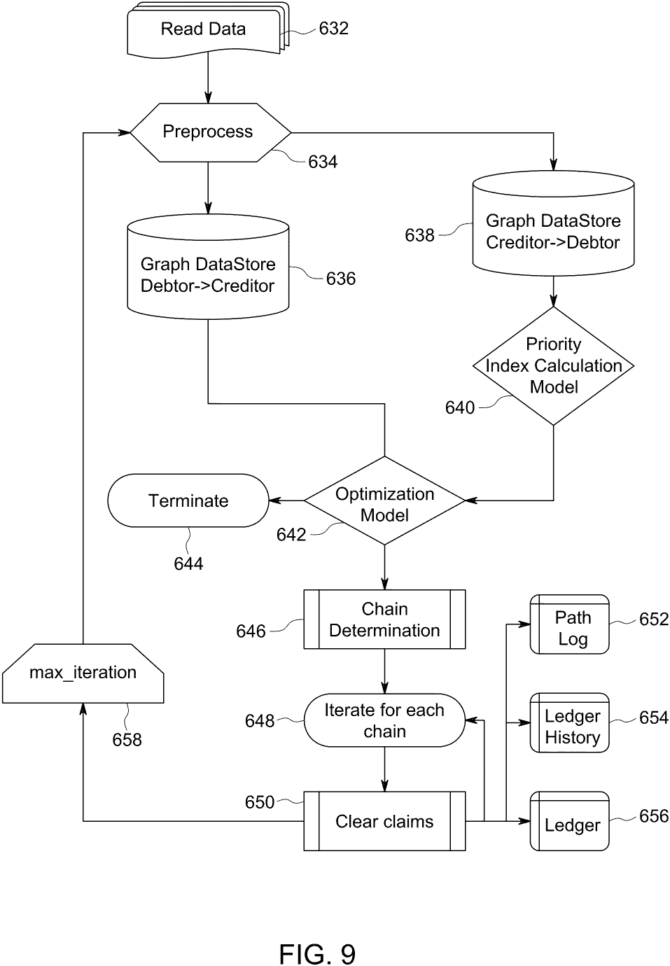

Credit clearance system 100 follows the process for optimization techniques defined in FIG. 9:
a. starts preprocesses 634 by reading data 632 to create dataset of Graph Data Store from Debtor to Creditor 636 and dataset of Graph Data Store from Creditor to Debtor 638
b. calculates weights receivables of users by using Priority Index Calculation Model 640 with inclusion of a value of the flow of receivables through the directed graph based dataset of Graph Data Store from Creditor to Debtor 638,
c. runs optimization model of relevant chains (zero-sum-chains, public-chains and discount chains) based on dataset of Graph Data Store from Debtor to Creditor 636 and weights receivables of users,
d. terminate 644 the model if no solution exists,
c. runs Chain Determination 646 to distinct amount form each user to another user in a chain
e. iterate for each chain 648 and clear claims 650 for this iteration,
f. updates dataset of pathlogs 652, ledger history 654 and ledger 656 to monitor results of iteration,
g. moves to the next iteration to make sure there is no chain left in the remaining dataset by setting a maximum iteration 658 number such as 10 or put a flag to terminate the process.

Credit clearance system 100 can also use a general optimization methodology to solve zero-sum chains 126 and public chains 128. Since the number of users in credit clearance system 100 will be so high, credit clearance system 100 has to parse the data by using priority index that current technologies can solve zero-sum chains 126 and public chains with an optimal solution. Credit clearance system 100 can use a general optimization methodology to identify chains. The general optimization methodology is as follows. Let X_{i,j} be the transfer amount from user i to j. The objective function is to maximize total weighted transfer amount. These weights (the Priority Index) (Cₚ) are a priori calculated to give importance to each payable, user, or path. The constraints of this graph problem are:
a) Transfer amount shall not be negative,
b) Transfer amount shall not be higher than the Payable amount (Amount_{i,j} ),
c) Flow balance constraints state that for each user:

For zero-sum chains 126, the Transfer amount from that user is equal to the Transfer amount to that user.

For chains intended to distribute funds at stages of the public chains 128, for each user (Public Users, Beneficiary Users and Other Users) deducted amount from that user minus the deducted amount to that user is equal to Public Money (Kᵢ), money to be received by Beneficiary Users (Lⱼ) and zero, respectively.

Objective function may be:

$$m a x {\sum }_{i} {\sum }_{j} {c}_{\text{} i , j} {X}_{i , j}$$

subject to constraint conditions for zero-sum chains 126:

$$0 \leq {X}_{i , j} \leq A m o u n {t}_{i , j} ∀ i , j$$

$${\sum }_{j} {X}_{i , j} - {\sum }_{j} {X}_{j , i} = 0 ∀ i$$

subject to constraint conditions for public chains 128:

$$0 \leq {X}_{i , j} \leq A m o u n {t}_{i , j} ∀ i , j$$

$${\sum }_{j ∈ O U} {X}_{i , j} - {\sum }_{j ∈ O U} X {}_{j , i} = 0 ∀ i ∈ O t h e r U s e r s$$

$${\sum }_{j ∈ P U} X {}_{i , j} \leq K {}_{i} ∀ i ∈ P u b l i c U s e r s$$

While solving directed paths, one choice is put all information once and solve them all. Practically this will give more optimal solution. For instance, government is major buyer for credit clearance system 100. In this case, they may request a priority to collect their taxes by paying their debts with the help of payables and receivables of companies. Credit clearance system 100 may use only entries of Public and Users of database and force algorithm 118 to determine zero-sum chains 126 for public users within this data set so. A public entity will be in the chain when such public entity becomes a user and prioritization will be determined according to related public chain 128 or zero-sum chain 126. This will help (government to collect their taxes before banks and central counterparties. The second run will be for banks. There may not be a public entity in this zero-sum chain 126. That means, credit clearance system 100 may add banks data into the remaining dataset to determine zero-sum chain 126 to make sure at least one bank in any chain. The next runs will be inclusion of available limits of group companies. The next run will be available limits of firms. If a company has receivables to pay its debts, this will be used primarily. Afterwards, if a company has an exposure above credit risk limit, credit clearance system 100 may help them to shift and diversify by using available limits of group companies. That means available limits will be used a kind of advance payment to group companies. Credit clearance system 100 may pay one companies debts with collection from another company exceeding credit limit. Furthermore, credit clearance system 100 may help companies transfer receivables exceeding credit limits to another business partner based on available limit within a part of diversification chains 124.

### V.D. Calculation of Diversification Chains

Diversification for a bank’s credit portfolio is the process of allocating loans to reduce exposure to any one particular company, group, industry, geography, or category of loans. Diversification requires a lender (a bank or any other lender) to lend more money to high/good credit rating (prime) borrowers, and to diversify lending across different loan parameters. Banks generally set credit limits for each borrower, and across lending sectors, and identify credit worthiness of all borrowers, and structure their lending to increase diversification across various lending sectors. However, prime borrowers generally do not need much financing from banks. When prime borrowers do need credit, they want below-market interest rates (below market even for similar prime borrowers). Due to funding cost, banks are generally unable to accommodate expectations of such prime companies. These facts leave allocated limits unused and prevent banks from reaching their diversification targets.

As one possibility, in computing zero-sum chains 126, Chain Pattern Extractor Model 668 may use basically the same algorithm as for zero-sum chains 126, with the coefficients of the optimization reweighted to improve loan diversification. Payable/receivable pairs for banks lending to sub-prime borrowers, or to borrowers in overweighted loan sectors, may be overweighted, so that the Chain will favor payments that reduce payables/receivables to sub-prime borrowers and reduce lending in sectors where a bank’s exposure is over the ratio that is set by desirable diversification. Likewise, payable/receivable pairs for loans to prime borrowers, and to lending sectors where the bank wants to increase exposure to improve diversification, may be underweighted or even removed from the set eligible for consideration, so that fewer of those payable/receivable pairs are added to the chain. Likewise, Chain Pattern Extractor Model 668 may overweight in favor of retiring payables that are over the credit limit that the payee has extended to the payor/debtor. By structuring chains this way, Chain Pattern Extractor Model 668 may tend to improve diversification of a bank’s debt portfolio, and tend to favor payoff of loans that are over credit limits. In this case, resolution of the chain may proceed in largely the same as for zero-sum chains 126.

FIG. 10 illustrates a simplified calculation of the diversification chain 124. Credit clearance system 100 may help users to diversify their short-term credit and liquidity risks by using diversification chains 124. Credit clearance system 100 runs algorithm 118 in an order to transfer receivables from other to users within the firm limits optimally to increase likelihood of collection by using diversification chains 124. Firm limits allow users to transfer receivables from other to users within firm limits. Credit clearance system 100 determines amounts of receivables from each counterparty and their firm limits assigned by a user. Users request from credit clearance system 100 to keep their exposures due to receivables in the system within Firm Limit. Credit clearance system 100 determines available limits (positive values of deduction) of each user and breaching exposures (negative values of deduction) by deduction of receivable amounts from Firm Limits. If the amount of available limit is less than the breaching exposures from counterparties, Credit clearance system 100 inserts only available limits of those counterparties to the process as payables so that receivables from counterparties with breaching exposures can be transferred to those counterparties with available limits. If the amount of available limit is higher than the breaching exposures from counterparties, diversification may be improved by taking account network value ratio (network values 120 of each user over amount of receivables) and Firm Limits. In a simple model without including network value ratio, the example recommended changes for diversification chain may be calculated as follows. As shown in FIG. 11, credit clearance system 100 takes a weighting of the firm limits 690 for the counterparties. Weightings 692 are weightings of firm limits 690. Current Receivables 694 is the Receivables of user 820 before the zero-sum chain created and completed. Recommended receivables 696 are calculated by Weightings 692 multiplied by Total of Current Receivables 664. Recommended change 698 is recommended receivables 696 minus current receivables 694. Total of each column 699 is shown as well. Credit clearance system 100 enters recommended change 698 as payables to user 812 and user 813 diversify the receivables from user 811. This diversification reduces the credit risk and increases the likelihood of collecting the Receivables early. As a general methodology, credit clearance system 100 will improve the calculation methodology for the recommended change by using optimization techniques. The aim of optimization is to maximize network value 120 of receivables (weighted receivable amount) for each user by adding constraints such as credit limit to counterparty (firm limit). Credit clearance system 100 can add constraint into the optimization such as minimum threshold value or de minimus rule so as to reduce unnecessary changes.

Credit clearance system 100 can also use a general optimization methodology to solve diversification chains. In cases where the number of users in the system is high, System Operator 800 may parse the data by using priority index in a way that current technologies can solve Diversification chains with an optimal solution.

The general methodology is as follows. Let X_{i,j} be the recommended receivable amounts from user i to j. The objective function is to maximize weighted receivable amount, namely Network Value 120 of Receivables. These weights (c_{i,j}) are a priori calculated to show network value 120 divided by accounts receivables, namely Network Value Ratio. The constraints of this network problems are:
a) Recommended receivables shall not be negative,
b) Recommended receivables shall not be higher than the amounts of Firm Limits (Limits_{i,j}),
c) Flow balance constraints state that the total of recommended receivable amount from that user shall not be higher than total of current receivable amount from that user (Amount_{i,j}) .

Objective function may be:

$$m a x {\sum }_{i} {\sum }_{j} {c}_{\text{} i , j} {X}_{i , j}$$

subject to constraints:

$$0 \leq {X}_{i , j} \leq L i m i {t}_{i , j} ∀ i , j$$

$${\sum }_{i} {\sum }_{j} {X}_{\text{} i , j} - {\sum }_{i} {\sum }_{j} A m o u n t {}_{i , j} = 0$$

Credit clearance system 100 checks if the total network value 120 of receivables increased. If it is not increased, there will be no changes in receivables due to diversification chains. Otherwise, credit clearance system 100 determines the amounts of recommended receivables (X_{i,j}) above current receivables (Amount_{i,j}) and enters these amounts as recommended changes into database 110 as payables. Credit clearance system 100 runs to determine chains accordingly. The recommended changes can be used to solve the chains with linear programming or optimization.

Consider the following example given in FIG. 4. User 820 has receivables of $130 from user 811. User 811 has receivables of $80 and $70 from user 815 and user 816 respectively. User 815 and user 816 have receivables of $110 and $120 from user 812 and user 813 respectively. :

| payable/receivable owed | | Obligee receivable owed to | | | | | |
|---|---|---|---|---|---|---|---|
| | | 811 | 812 | 813 | 815 | 816 | 820 |
| Obligor payable owed from | 811 | | | | | | 130 |
| | 812 | | | | 110 | | |
| | 813 | | | | | 120 | |
| | 815 | 80 | | | | | |
| | 816 | 20 | | | | | |
| | 820 | | | | | | |
| | Total | 100 | 0 | 0 | 110 | 120 | 130 |

The above optimization calculation may compute that the optimal allocation of receivables (considering diversification, credit limits, and the like) may be:

| Recommended | 811 | 812 | 813 | 815 | 816 | 820 |
|---|---|---|---|---|---|---|
| 811 | 0 | 0 | 0 | 0 | 0 | 30 |
| 812 | 0 | 0 | 0 | 110 | 0 | 0 |
| 813 | 0 | 0 | 0 | 0 | 120 | 0 |
| 815 | 80 | 0 | 0 | 0 | 0 | 0 |
| 816 | 20 | 0 | 0 | 0 | 0 | 0 |
| 820 | 0 | 80 | 20 | 0 | 0 | 0 |
| Total | 100 | 80 | 20 | 110 | 120 | 30 |

Credit clearance system 100 may compute that the change necessary to achieve this optimal recommendation is:

| | | | | | | |
|---|---|---|---|---|---|---|
| Recommended Change | 811 | 812 | 813 | 815 | 816 | 820 |
| 811 | | | | | | 100 |
| 812 | | | | | | |
| 813 | | | | | | |
| 815 | | | | | | |
| 816 | | | | | | |
| 820 | | -80 | -20 | | | |

To achieve this result, some of the changes are resolvable using the same cash transfer mechanisms as for zero-sum chains (as discussed in § V.F below). For example, user 811′s agreement with credit clearance system 100 may authorize payment of $100 from user 811 to user 820 to reduce the receivable by $100, from $130 to $30.

Other changes require a reallocation of payables/receivables among the parties. Agreements between the parties and System Operator 800 and/or credit clearance system 100 may authorize credit clearance system 100 to create additional debt. For example, user 820′s agreement with System Operator 800 may authorize System Operator to create a loan from user 820 to user 812 of $80, another loan from user 820 to user 813 of $20.

### V.E. Calculation of Discount Chains

The existing credit market has deadlocks. Banks are limited in their ability to extend credit to sub-prime customers because of their low credit ratings, risk averseness and market conditions. Conversely, banks may be unable to extend credits to prime customers because of their unwillingness to borrow with current rate. Those prime customers may also be unwilling to pay debt to sub-prime customers, to whom they are also sellers, on time due to their market power. In Turkey, sub-prime customers cannot access to bank credit. They go to factoring companies with high interest rates to discount their receivables. If they have post-dated checks in their hand, they are lucky to obtain cash by discounting the post-dated check. If their receivable is based on invoice and contract, it is very hard for them to cash out that money from factoring firms with high interest costs. They have to get consent of debtor with a maturity date. Public notary has to be a part of this process. This is really problematic process for Turkish business people. Discount chains has name with discount due to discounting of receivables or checks from factoring companies.

Credit clearance system 100 may help banks, prime customers and sub-prime customers to match their expectations in a market mechanism. By using discount chain 130, banks may use credit clearance system 100 to give cash credit to users (their prime customers) and leave the money in accounts of users willing to pay a flat rate commission (for example, 1%) predetermined by credit clearance system 100. Credit clearance system 100 collects this flat rate commission from their escrow accounts of users and pays to banks as commission incomes. Banks generally have established credit limits for their prime customers, and may enter them into credit clearance system 100. Banks enter the cash amount to provide users by taking into account the flat rate commission. Users enter the cash amount requested to collect their receivables with flat rate commission.

A discount chain 130 is just to receive cash credit from banks with a flat fee. Users accept to pay a flat commission so that credit clearance system can help banks to be willing to extend credit to users and users to receive cash payment from its receivables. Banks willing to credit only prime customers and don’t want to take risk of sub-prime customers. This will facilitate to meet expectations of banks, prime customers and sub-prime customers.

After banks enter amount of cash credit provided on table CCProvided 228 and users enter amount of cash credit requested on table CCRequested 230 into database 110, credit clearance system 100 runs to determine discount chains 130. Credit clearance system 100 runs after receiving amounts in table CCProvided 228. Credit clearance system 100 uses algorithm 118 and determines directed routes from the Bank providing cash credit to users requesting cash.

Credit clearance system 100 follows the process defined in FIG. 6. Chain Pattern Extractor Model 668 selects only chains that directed from Banks providing cash credit to users requesting cash determined.

Credit clearance system 100 can also use a general optimization methodology to solve Discount chains. Since the number of users in credit clearance system 100 will be so high, Credit clearance system 100 has to parse the data by using priority index that current technologies can solve Discount chains with an optimal solution. Credit clearance system 100 can use a general optimization methodology to solve Discount chain. The general methodology is as follows. Let X_{i,j} be the transfer amount from user i to j. The objective function is to maximize the total weighted deducted amount. These weights (the Priority Index) (c_{d}) are a priori calculated to give importance to each Payable, user or path. The constraints of this network problems are:
a) Transfer amount shall not be negative,
b) Transfer amount shall not be higher than the amount of Payables (Amount_{i,j}),
c) Flow balance constraints state that for each user (BU- Bank Users, RU- Users requesting cash and OU- Other Users) deducted amount from that user minus the deducted amount to that user is equal to Cash Credit (Cᵢ), money to be received by Users requesting cash (Rⱼ ) and zero, respectively.

Objective function may be:

$$m a x {\sum }_{i} {\sum }_{j} {c}_{\text{} i , j} {X}_{i , j}$$

subject to constraints:

$$0 \leq {X}_{i , j} \leq A m o u n {t}_{i , j} ∀ i , j$$

$${\sum }_{j ∈ O U} {X}_{i , j} - {\sum }_{j ∈ O U} X {}_{j , i} = 0 ∀ i ∈ O t h e r U s e r s$$

$${\sum }_{j ∈ B U} X {}_{i , j} \leq C {}_{i} ∀ i ∈ B a n k U s e r s$$

$${\sum }_{i ∈ R U} X {}_{i , j} \leq R {}_{j} ∀ i ∈ R e q u e s t i n g U s e r s$$

### V.F. Implementation: Transfer of Money Through Accounts

For each of the following implementation approaches, System Operator 800 or credit clearance system 100 may get necessary documentation of account number, and authorization to make transfers in and out. At the beginning of a run, credit clearance system 100 may check users’ accounts for any payment restrictions 116, such as an asset freeze or lien, bankruptcy, sufficient funds for any transfers that might be required, anti-money laundering and combating the financing of terrorism (AML / CTF). Users having legal restrictions may be excluded from further processes.

Credit clearance system 100 transfers amounts among accounts of users. Users can see their transactions money received From/To, Amount and Notes of account statements 140 produced based on the Table Statements 156. The Amount will be with plus sign for receivables and negative sign for payments. Users can use this statement for their booking and other legal documents. Credit clearance system 100 may use various payment systems, perhaps one owned and operated by System Operator 800, perhaps one or more payment systems owned by separate entities.

### V.F.1. Cut-Off Time 112

Desirably, credit clearance system 100 runs at time when other cash flows are quiescent. For example, it is desirable that if a zero-sum chain 126 is detected, its payment orders can be executed before the payable/receivable is executed by another payment system, and that the funds available in the right account at the moment the chain is computed are still in the same account when payment orders for the chain are executed. This may be effected by implementing a cut-off time 112, typically at a time of day when other financial markets are closed and largely quiescent, but still at a time within the calendar date on which a transaction is set to occur. 11PM or 23:00, or 2AM the next morning, may be good times for algorithm 118 to run, and to effect execution of payment orders. Alternatively, credit clearance system may run from time-to-time during the day, and cut-off times 112 may occur hourly.

### V.F.2. Approximate Matching

In some cases, credit clearance system 100 may identify chains where one or more of the links is an approximate match, rather than a perfect match.
In the library book example of § II, perhaps two libraries are in the same library system and geographically near each other, so it’s easier to settle the book return between those two libraries, than to return through the conventional interlibrary loan system.
Some of the payables/receivables may have slightly different maturity dates than others.
In some cases, a payable to one entity may be matched or chained to an receivable from another entity if the two entities provide System Operator 800 consent to do so. For example, the two entities may be subsidiaries within a single corporate parent, or one may be a loan guarantor for the other.

### V.F.3. Escrow or Special Purpose Accounts

In some cases, credit clearance system 100 may create a series of escrow or third-party trust accounts, one account for each user. These accounts may be held by System Operator 800 or credit clearance system 100 for benefit of respective users. To execute a chain and retire payable/receivable pairs, credit clearance system 100 may issue payment orders between these accounts, purely as an internal matter. This may save on SWIFT interbank transfer fees.

For zero-sum chains, the default state of each account is a zero balance, and the transfers in and out are only transient. For public chains and discount chains, the residuals remain in the escrow account, and may be transferred out to the user’s operating account.

### V.F.4. Block Clearing Using Banks and SWIFT as Transfer

Credit clearance system 100 may use standard interbank transfers, such as SWIFT, as a payment system. After creation of chains, credit clearance system 100 sends the information to the payment system, including order number, transfer amount, account number transferred from and account number transferred to. Credit clearance system 100 may use APIs, web service etc. for the transfer of the Table TransferOrder 262.

### V.F.5. Block Clearing Using API-Based Transfer Agents Such as Apple Pay, Google Pay

Credit clearance system 100 may use one of the leading payment systems such as Google Pay, Apple Pay or Novi for money transfers 138. Credit clearance system 100 may use APIs of those payment systems to open an escrow account for each user and gets necessary documentation. Credit clearance system 100 may take full control of the account to make sure the user that owns the account cannot interfere the process of money transfer 138 among accounts. Credit clearance system 100 makes sure that there are no legal restrictions 116 such as anti-money laundering and combating the financing of terrorism (AML / CTF). Credit clearance system 100 excludes users having legal restrictions from further processes. After creation of chains, credit clearance system 100 sends the information to the payment system through APIs, including order number, transfer amount, account number transferred from and account number transferred to. Credit clearance system 100 can be payment system as well.

### V.F.6. Transfers Using a Net-Offset Clearer (ACH)

Credit clearance system 100 may use a net-offset clearer such as an ACH. Banks open an escrow account for each user and gets necessary documentation and informs the account number to the ACH. The bank is responsible for implementing account controls for restrictions 116 such as anti-money laundering and combating the financing of terrorism (AML / CTF). Banks exclude users having legal restrictions from further processes. Banks collects all data for database 110 and sends to the ACH. ACH, as System Operator 800, runs algorithm 118 and creates chains. After creation of chains, the ACH sends the information to the related bank for own accounts, including order number, transfer amount, account number transferred from and account number transferred to. The ACH may use APIs, web service etc. for the transfer of the Table TransferOrder 262. The ACH may outsource some services of Credit clearance system 100.

### V.F.7. Combining Transfer Networks

Credit clearance system 100 may run individually in a sequence for each transfer network to reduce default risk. Users may have choice to insert their data into credit clearance system 100 based on preferences. Credit clearance system 100 may be set up to identify chains that cross multiple transfer networks, and that may create additional default risk. Risk may be mitigated by imposing additional constraints to freeze accounts while a chain’s transfers are executed. Alternatively, a single account that is enrolled in all payment networks may be used as a “hub” so that all transfers that cross payment networks transfer into this hub account on one transfer network, and then out again to the next account on the chain on another transfer network.

### V.G. Present Value of Receivables and Payables

Credit clearance system 100 can be used to clear payables and receivables with future maturities. For each, a user may provide a payor/payee, an amount, and a maturity date. Credit clearance system 100 may use present values of notional amounts and use present values in calculation of chains. The remaining balance after chain deduction may be carried to future value. Credit clearance system 100 may calculate amounts of difference between the notional amount inserted at the beginning and the amount transmitted through accounts. These amounts are interest incomes of paying users due to early payments and interest costs of receiving users due to early receipt of money. This amount transferred accounts of System Operator 800, paying receiver and receiving users to clear. System Operator 800 acts as agents at the Maturity for this zero-sum chain, namely System Operator 800 -> The Paying User -> The Receiving User -> System Operator 800. System Operator 800 uses a benchmark interest rate acceptable by users such as LIBOR, T-Bond Rate, or Central Bank Policy Rate. System Operator 800 can create a System only for payables and receivables with maturities.

System Operator 800 may insert one or more interest rate and calculation date to be stored in the Table InterestRates 248. System Operator 800 uses interest rate in the Table InterestRates 248 and check number, check amount and maturity in the Table Checks 234 to determine PVAmount. The RemainingBalance is the amount after deduction of trx_amnt in the Table Pathlog 256 from PVAmount. The FVRemainingBalance is the future value of the RemainingBalance with the InterestRate.

### V.H. Defaults

Receivables always present default risk and credit risk. Credit clearance system 100 may reduce defaults by reducing batch time and putting additional controls. Credit clearance system 100 controls the escrow account with the process of check users’ escrow accounts for any restriction with the process of account controls for restrictions 116. Algorithm 118 determines chains and money transfer completed in very short time of period. Additional controls can be inserted to reduce further default risk and credit risk. Credit clearance system 100 may run batches at midnight so that there is no infringement to accounts. System Operator may use a small amount of money to make sure there is problem in accounts before and after calculation of chains. For instance, $1 is used to make sure there is no restriction in the accounts. System Operator can transfer $1 through accounts in the chain. Some seconds after this $1 completes its chain move, the rest of the money can be transferred through accounts. Therefore, the risk can be minimized. A reasonable money i.e. $1000 is transferred multiple times such as 10 times for $10.000. If legal base is good enough, we can even debit and credit to those account without transferring money. In some cases, in order to assure that benefits of credit clearance system 100 may be realized by many actors in an economy, a government may issue regulations that give special “untouchable” status to an escrow account of credit clearance system 100.

### VI. Embodiments

In some embodiments, a computer processor processes a database to identify a chain of database records. The records have links to other records. The processing identifies a chain of records though the links such that the records and links taken together as a chain meet a property specified as a parameter to the processing, the property describing a property of the chain as a whole. After the chain is identified, the computer processor issues computer messages to computers of a settlement agent, to holders of the goods or instruments, and/or to transfer agents for the goods or instruments, instructing computers of recipient agents or holders to transfer goods or instruments under a global transaction that settles obligations of the chain.

In some embodiments, a computer processor processes a database to identify a chain of database records. Records of the database describe respective payable/receivable obligations. Each payable/receivable obligation record stores an obligor, an obligee, and an amount. The processor is programmed to identify a chain containing records such that the obligee of a record in the chain corresponds to the obligor of the next record in the chain. After the chain is identified, the computer processor issues instructions to computers of a settlement agent, to parties to the payables/receivables, and/or to transfer agents for the payables/receivables, instructing computers of agents or holders to transfer funds or payment obligations under a global transaction that settles obligations of the chain.

Embodiments of the invention may include one or more of the following features, singly or in combination. Records of the database may describe books due to libraries on inter-library loan from a source library to a destination library for loan to a patron. The processing may be programmed to identify a chain of records in the database, the chain containing records such that (for records other than the first and last in the chain) the destination library of a record in the chain is the source library of the next record in the chain. After the chain is identified, the computer processor may issue instructions to computers of destination libraries to each hold the respective book when returned by the borrower, and to cancel obligations of destination libraries to return the books to the source libraries, and to update the holding inventories of the libraries. Records of the database may describe locations of shipping containers, and obligations to return the shipping containers from current ports to destination ports, the processing programmed to identify a chain of records in the database, the chain containing records such that (for records other than the first and last in the chain) the destination port of a record in the chain is the current port of the next record in the chain. These features may be used singly, or in combination with each other. The obligee of the last record in the chain ma correspond to the obligor of the first record in the chain. After the chain is identified, the processor may issue instructions to a settlement agent, to holders of the payables/receivables, and/or to transfer agents for the payables/receivables, to extinguish an amount of each payable/receivable of the chain. The obligor of the first record in the chain may be a public sector entity. After the chain is identified, the processor may issue instructions to a settlement agent, to holders of the payables/receivables, and/or to transfer agents for the payables/receivables, to extinguish an amount of each payable/receivable of the chain; the amount monotonically decreasing at each record of the chain except the last. The property is a chain of payment obligations, in which the obligor of the last obligation in the chain is chosen because that obligor has a lower credit rating than the first obligor in the chain, and the global transaction is to replace the obligor of the last obligation with the obligor of the first obligation and to retire at least in part the obligations of the links of the chain other than the first. The records describing payable/receivable obligations. Each payable/receivable obligation record may store an obligor, an obligee, and an amount, the processing programmed to compute an optimized allocation of payable/receivable obligations among obligees for distribution across various parameters programmed into an optimization model. After the chain is identified, the computer processor may issue instructions to a settlement agent, to holders of the payable/receivable obligations, and/or to transfer agents for the payables/receivables, to transfer funds or payment obligations, and to create new payable/receivable obligations, to achieve the computed optimized allocation. After the chain is identified, the computer processor may issue instructions to computers of shippers and ports to each hold the respective shipping containers of the records in the chain, and to cancel obligations to transfer the shipping containers to the destination ports. The chain may be formed of imperfectly-fungible instances of goods or instruments, and the processing to identify the chain may rely on a selected degree of difference to identify chains of imperfectly fungible obligations. The computer processor may communicate with computer systems of obligors and obligees to gather accounts payable and accounts receivable information. At least one payee may corresponding to a payor may be different parties under an arrangement to transfer funds between each other, the correspondence having been communicated to the computer processor before the database processing begins. The database processing may be programmed to recognize payable/receivable obligations having different maturity dates from each other as eligible for matching into a chain, a degree of acceptable difference having been communicated to the computer processor before the database processing begins. The computer processor may be programmed to issue instructions to agents and/or holders to settle the payable/receivable obligations at notional value, or at present value. At least one of the obligors may be a liquidity lender, and the payable/receivable obligation for that liquidity lender may be not recorded in the database before the database processing begins. The database processing may run in a series of passes, programmed to promote resolution of some payable/receivable obligations over payable/receivable obligations. The database processing may compute the chain as a directed graph among the database records. The database processing may be computed the chain using a linear programming optimization algorithm. After the chain may be identified, the computer processor may issue instructions to an escrow agent instructing the escrow agent to transfer funds or payment obligations among accounts in trust for the obligors and obligees held by a common transfer agent. After the chain is identified, the computer processor may issue instructions to transfer funds over a payment network.

### VII. Computer Implementation

Various processes described herein may be implemented by appropriately programmed general purpose computers, special purpose computers, and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hardwired circuitry or custom hardware may be used in place of, or in combination with, some or all of the software instructions that can implement the processes. Algorithms other than those described may be used.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer.

The invention claimed is:

1. A method, comprising the steps of:
by a computer processor, processing a database to identify a chain of database records, each record of the chain storing a designation of the record’s obligor, the record’s obligee, and an obligation owed by the obligor to the obligee, and one or more links to other records, the processing programmed to identify a chain of records linked in a chain such that the obligee of one record in the chain is the same as the obligor of the next record of the chain, obligations of successive records in the chain being either fungible or nearly-fungible to a degree of eligibility that has been communicated to the computer processor before the database processing begins, such that the records and links taken together as a chain meet a property specified as a parameter to the processing, the property describing a property of the series of obligations through successive obligors and obligees of the chain as a whole; and
by the computer processor, based on the identified chain, computing and issuing computer messages to computers of a settlement agent, to holders of the goods or instruments, and/or to transfer agents for the goods or instruments, instructing computers of recipient agents or holders to transfer goods or instruments under a global transaction that settles obligations of the linked records of the chain.

2. The method of claim 1, further comprising the steps of:
by a computer processor, processing a database to identify a chain of database records, records of the database describing books due to libraries on inter-library loan from a source library to a destination library for loan to a patron, the processing programmed to identify a chain of records in the database, the chain containing records such that (for records other than the first and last in the chain) the destination library of a record in the chain is the source library of the next record in the chain, or a nearby library; and
by the computer processor, after the chain is identified, issuing instructions to computers of destination libraries to each hold the respective book when returned by the borrower, and to cancel obligations of destination libraries to return the books to the source libraries, and to update the holding inventories of the libraries.

3. The method of claim 1, further comprising the steps of:
by a computer processor, processing a database to identify a chain of database records, records of the database describing locations of shipping containers, and obligations to return the shipping containers from current ports to destination ports, the processing programmed to identify a chain of records in the database, the chain containing records such that (for records other than the first and last in the chain) the destination port of a record in the chain is the current port of the next record in the chain; and
by the computer processor, after the chain is identified, issuing instructions to computers of shippers and ports to each hold the respective shipping containers of the records in the chain, and to cancel obligations to transfer the shipping containers to the destination ports.

4. The method of claim 1, further comprising the steps of:
by a computer processor, processing a database to identify a chain of database records, records of the database describing respective payable/receivable obligations, each payable/receivable obligation record storing an obligor, an obligee, and an amount, the processing programmed to identify a chain containing records such that (for records other than the first and last in the chain) the obligee of a record in the chain corresponds to the obligor of the next record in the chain; and
by the computer processor, after the chain is identified, issuing instructions to computers of a settlement agent, to parties to the payables/receivables, and/or to transfer agents for the payables/receivables, instructing computers of agents or holders to transfer funds or payment obligations under a global transaction that settles obligations of the chain.

5. The method of claim 4:
wherein the obligee of the last record in the chain corresponds to the obligor of the first record in the chain; and
further comprising the steps of by the computer processor, after the chain is identified, issuing instructions to a settlement agent, to holders of the payables/receivables, and/or to transfer agents for the payables/receivables, to extinguish an amount of each payable/receivable of the chain.

6. The method of claim 4:
wherein the obligor of the first record in the chain is a public sector entity; and
further comprising the step of by the computer processor, after the chain is identified, issuing instructions to a settlement agent, to holders of the payables/receivables, and/or to transfer agents for the payables/receivables, to extinguish an amount of each payable/receivable of the chain; the amount monotonically decreasing at each record of the chain except the last.

7. The method of claim 4, wherein:
the property is a chain of payment obligations, in which the obligor of the last obligation in the chain is chosen because that obligor has a lower credit rating than the first obligor in the chain, and the global transaction is to replace the obligor of the last obligation with the obligor of the first obligation and to retire at least in part the obligations of the links of the chain other than the first.

8. The method of claim 1, further comprising the steps of:
by a computer processor, processing a database of records, the records describing payable/receivable obligations, each payable/receivable obligation record storing an obligor, an obligee, and an amount, the processing programmed to compute an optimized allocation of payable/receivable obligations among obligees for distribution across various parameters programmed into an optimization model; and
by the computer processor, after the chain is identified, issuing instructions to a settlement agent, to holders of the payable/receivable obligations, and/or to transfer agents for the payables/receivables, to transfer funds or payment obligations, and to create new payable/receivable obligations, to achieve the computed optimized allocation.

9. The method of claim 4, wherein:
the chain is formed of fungible or imperfectly-fungible instances of the good or instrument, and the processing to identify the chain relies on a selected degree of difference to identify imperfectly-fungible obligations.

10. The method of claim 4, further comprising the step of:
by the computer processor, communicating with computer systems of obligors and obligees to gather accounts payable and accounts receivable information.

11. The method of claim 4, wherein:
at least one payee corresponding to a payor are different parties under an arrangement to transfer funds between each other, the correspondence having been communicated to the computer processor before the database processing begins.

12. The method of claim 4, wherein:
the database processing is programmed to recognize payable/receivable obligations having different maturity dates from each other as eligible for matching into a chain, a degree of acceptable difference having been communicated to the computer processor before the database processing begins.

13. The method of claim 4, wherein:
the computer processor is programmed to issue instructions to agents and/or holders to settle the payable/receivable obligations at notional value.

14. The method of claim 4, wherein:
the computer processor is programmed to issue instructions to agents and/or holders to settle the payable/receivable obligations at present value.

15. The method of claim 4, wherein:
for at least one of the payable/receivable obligations, the payable obligor is a liquidity lender, and the payable/receivable obligation for that liquidity lender is not recorded in the database before the database processing begins.

16. The method of claim 4, further comprising the steps of:
running the database processing in a series of passes, programmed to promote resolution of some payable/receivable obligations over payable/receivable obligations.

17. The method of claim 4, further comprising the steps of:
computing the chain as a directed graph among the database records.

18. The method of claim 4, further comprising the steps of:
computing the chain using a linear programming optimization algorithm.

19. The method of claim 4, further comprising the steps of:
by the computer processor, after the chain is identified, issuing instructions to an escrow agent instructing the escrow agent to transfer funds or payment obligations among accounts in trust for the obligors and obligees held by a common transfer agent.

20. The method of claim 4, further comprising the steps of:
by the computer processor, after the chain is identified, issuing instructions to transfer funds over a payment network.
